(19) United States
(12) Patent Application Publication
(10) Pub. No.: US 2011/0301277 A1
(43) Pub. Date: Dec. 8, 2011

(54) BOUNDARY BREAKER PAINT, COATINGS AND ADHESIVES

(76) Inventor: WILLIAM L. JOHNSON, SR., Grove, OK (US)

(21) Appl. No.: 13/181,476

(22) Filed: Jul. 12, 2011

Related U.S. Application Data
(63) Continuation-in-part of application No. 12/572,942, filed on Oct. 2, 2009.
Application No. 12/572,942 is a continuation-in-part of application No. 12/412,357, filed on Mar. 26, 2009, now abandoned.
(60) Provisional application No. 61/363,574, filed on Jul. 12, 2010.
(60) Provisional application No. 61/412,257, filed on Nov. 10, 2010.
(60) Provisional application No. 61/070,876, filed on Mar. 26, 2008.

(51) Int. Cl. C08K 3/40; B05D 1/02; B05D 1/34; C08L 33/00

(52) U.S. Cl. 524/494; 524/556; 427/427.4; 427/429; 427/426

(57) ABSTRACT

A composition comprising a fluid, and a material dispersed in the fluid, the material made up of particles having a complex three dimensional surface area such as a sharp blade-like surface, the particles having an aspect ratio larger than 0.7 for promoting kinetic boundary layer mixing in a non-linear-viscosity zone. The composition may further include an additive dispersed in the fluid. The fluid may be a polymer material. A method of moving the fluid to disperse the material within the fluid wherein the material migrates to a boundary layer of the fluid to promote kinetic mixing of the additives within the fluid, the kinetic mixing taking place in a non-linear viscosity zone.

### CROSS REFERENCE TO RELATED APPLICATIONS

This application claims the priority of U.S. patent application Ser. No. 12/572,942, filed Oct. 2, 2009, titled, “STRUCTURALLY ENHANCED PLASTICS WITH FILLER REINFORCEMENTS”, which claims priority to U.S. patent application Ser. No. 12/412,357, entitled “STRUCTURALLY ENHANCED PLASTICS WITH FILLER REINFORCEMENTS”, filed Mar. 26, 2009, which claims the priority of U.S. Provisional Patent Application No. 61/070,876 entitled “STRUCTURALLY ENHANCED POLYMER WITH FILLER REINFORCEMENTS”, filed Mar. 26, 2008. This application additionally claims priority to U.S. Provisional Patent Application No. 61/363,574, filed Jul. 12, 2010, titled “PANT, COATINGS AND ADHESIVES”, and U.S. Provisional Patent Application No. 61/412,257, titled “PAINT, COATINGS AND ADHESIVES”, filed Nov. 10, 2010, the contents of each of which are hereby incorporated by reference.

### FIELD OF THE INVENTION

A composition for promoting kinetic mixing of additives within a non-linear viscosity zone of a fluid such as acrylic, enamel, polyurethanes, polyurea, epoxies, mastic and a variety of other polymers including two-part or single component filled or unfilled.

### BACKGROUND OF THE INVENTION

The coatings industry focuses on five primary characteristics for improvement, i.e., 1) adhesion to surfaces; 2) Ability to flow, i.e., surface wetting ability; 3) Suspension of additives; 4) Dispersion of additives; and 5) Durability (color shift caused by fading, weatherability and mechanical toughness).

With regards to category 5, durability from an aesthetic point of view relates to color shift, fading, weathering and scratch/marring resistance. From a mechanical point of view, durability relates to adhesion, hardness, flexibility, chemical resistance, water sorption, impact resistance, etc. Whether a polymer has good durability is affected by dispersion and suspension of additives such as pigments, UV stabilizers, fungicides, biocides, coupling agents, surface tension modifiers, plasticizers and hardened fillers for scratch protection/mar resistance, etc. If these additives are not disbursed throughout the polymer to produce a homogeneous mixture, then there will be regions that will produce durability failures.

Polymer performance in categories 1-5 are significantly affected by the viscosity of the binder, e.g., acrylic, enamel, urethane, urea, epoxies etc. For example:

a) The more viscous the binder material is, the less likely the binder material will adhere well to complicated surfaces such as a rough surface or very smooth surface due to difficulties associated with adequately wetting the surface. The viscosity of the binder material directly effects the flow. For example, an increased viscosity reduces the ability of the binder material to flow easily over surfaces making it difficult to achieve a thin-film thickness; b) A greater viscosity of the binder results in a better suspension of additives; c) The more viscous the binder, the harder it is to disperse materials evenly.

### SUMMARY OF THE INVENTION

The technology of the invention provides a unique solution to the above mentioned problems. The technology of the invention provides kinetic mixing of the boundary layer, which produces homogenous dispersion with micro and nano mixing that allows for reduction of expensive additives that may be environmentally damaging while still maintaining benefits associated with the additives. The technology of the invention uses environmentally safe, chemically stable solid particles to continuously mix materials as long as the fluid is flowing.

The invention relates to improvements in boundary layer mixing, i.e., the invention relates to the effects of structural mechanical fillers on fluid flow, wherein the particles have sizes ranging from nano to micron. In particular, the size ranges of the particles are from 500 nm to 1μ, more particularly, from 1μ, to 30μ, although any sub ranges within the defined ranges are also contemplated as being effective. The invention uses the principles of boundary layer static film coupled with frictional forces associated with a particle being forced to rotate or tumble in the boundary layer due to fluid velocity differentials. As a result, kinetic mixing is promoted through the use of the structural particles.

As an example, consider that a hard sphere rolling on a soft material travels in a moving depression. The soft material is compressed in front of the rolling sphere and the soft material rebounds at the rear of the rolling sphere. If the material is perfectly elastic, energy stored during compression is returned to the sphere by the rebound of the soft material at the rear of the rolling sphere. In practice, actual materials are not perfectly elastic. Therefore, energy dissipation occurs, which results in kinetic energy, i.e., rolling. By definition, a fluid is a material continuum that is unable to withstand a static shear stress. Unlike an elastic solid, which responds to a shear stress with a recoverable deformation, a fluid responds with irrecoverable flow. The irrecoverable flow may be used as a driving force for kinetic mechanical mixing in the boundary layer. By using the principle of rolling, kinetic friction and an increase of fluid sticking at the surface of the no-slip zone, adherents are produced. Fluid flow that is adjacent to the boundary layer produces an inertial force upon the adhered particles. Inertial force rotates the particles along the surface of mechanical process equipment regardless of mixing mechanics used, i.e., regardless of static, dynamic or kinetic mixing.

Geometric design or selection of structural particles is based on the fundamental principle of surface interaction with the sticky film in the boundary layer where the velocity is zero. Mechanical surface adherence is increased by increasing particle surface roughness. Particle penetration deep into the boundary layer produces kinetic mixing. Particle penetration is increased by increasing sharpness of particle edges or bladelike particle surfaces. A particle having a rough and/or sharp particle surface exhibits increased adhesion to the non-slip zone, which promotes better surface adhesion than a smooth particle having little to no surface characteristics. The ideal particle size will differ depending upon the fluid due to the viscosity of a particular fluid. Because viscosity differs depending on the fluid, process parameters such as temperature and pressure as well as mixing mechanics produced by sheer forces and surface polishing on mechanical surfaces will also differ, which creates a variation in boundary layer thickness. A rough and/or sharp particle surface allows a particle to function as a rolling kinetic mixing blade in the boundary layer. Hardened particles having rough and/or sharp edges that roll along a fluid boundary layer will produce micro mixing by agitating the surface area of the boundary layer.

Solid particles used for kinetic mixing in a boundary layer, i.e., kinetic boundary layer mixing material or kinetic mixing material, preferably have following characteristics:
Particles should have a physical geometry characteristic that allows the particle to roll or tumble along a boundary layer surface.
Particles shall have a surface roughness sufficient to interact with a zero velocity zone or a non-slip fluid surface to promote kinetic friction rather than static friction. The mixing efficiency of particles increases with surface roughness.
Particles should be sufficiently hard so that the fluid is deformed around a particle for promoting kinetic mixing through the tumbling or rolling effect of the particle.
Particles should be size proportional to the boundary layer of fluid being used so that the particles roll or tumble due to kinetic rolling friction.
Particles should not be too small. If the particles are too small, the particles will be caught in the boundary layer and will lose the ability to tumble or roll, which increases friction and promotes mechanical wear throughout the contact zone of the boundary layer.
Particles should not be too large. If the particles are too large, the particles will be swept into the bulk fluid flow and have a minimal, if any, effect on kinetic boundary layer mixing. The particles should have size and surface characteristics, such as roughness and/or sharp bladelike characteristics, to be able to reconnect in the boundary layer from the bulk fluid during the mixing process.
Particles can be solid or porous materials, manmade or naturally occurring minerals and or rocks.

Physical Geometry of Particles:

Particle shapes can be spherical, triangular, diamond, square or etc., but semi-flat or flat particles are less desirable because they do not tumble well. Semi-flat or flat particles tumble less well because the cross-sectional surface area of a flat particle has little resistance to fluid friction applied to its small thickness. However, since agitation in the form of mixing is desired, awkward forms of tumbling are beneficial since the awkward tumbling creates dynamic random generated mixing zones at the boundary layer. Random mixing zones are analogous to mixing zones created by big mixing blades operating with little mixing blades. Some of the blades turn fast and some of the blades turn slow, but the result is that the blades are all mixing. In a more viscous fluid, which has less inelastic properties, kinetic mixing by particles will produce a chopping and grinding effect due to particle surface roughness and due to sharp edges of the particles.

Spherical particles having extremely smooth surfaces are not ideal for the following reasons. First, surface roughness increases friction between the particle and the fluid, which increases the ability of the particle to remain in contact with the sticky and/or the non-slip zone. In contrast, a smooth surface, such as may be found on a sphere, limits contact with the sticky layer due to poor surface adhesion. Second, surface roughness directly affects the ability of a particle to induce mixing through tumbling and/or rolling, whereas a smooth surface does not. Thirdly, spherical shapes with smooth surfaces tend to roll along the boundary layer, which can promote a lubricating effect. However, spherical particles having surface roughness help to promote dynamic mixing of the boundary layer as well as promote lubricating effects, especially with low viscosity fluids and gases.

Advantages of this Technology Include:
Cost savings achieved by the replacement of expensive polymers with inexpensive structural material.
Cost savings achieved by increasing an ability to incorporate more organic material into polymers.
Cost savings achieved by increasing productivity with high levels of organic and/or structural materials.
Better disbursement of additives and/or fillers through increased mixing on large mechanical surfaces produced by boundary mixing.
Better mixing of polymers by grinding and cutting effects of the particles rolling along the large surface area as the velocity and compression of the polymers impact the surface during normal mixing operations.
Reduction of coefficient of friction on mechanical surfaces caused by boundary layer effects of static friction, which are replaced by rolling kinetic friction of a hard particle in the boundary layer.
Increased production by reduction of the coefficient of friction in the boundary layer where the coefficient of friction directly affects the production output.
Surface quality improvement: introduction of kinetic mixing particles produces a polymer rich zone on a mechanical surface due to rotation of the particles in the boundary layer during mixing, i.e., when mixing dyes, injecting in molds, etc. The polymer rich zone results in excellent surface finish whether the polymer is filled or unfilled.
The production of particle rotation and agitation of stagnant film of the boundary layer by kinetic mixing, which results in self-cleaning of the boundary layer to remove particulates and film.
Enhanced heat transfer due to kinetic mixing in the boundary layer, which is considered to be a stagnant film where the heat transfer is dominantly conduction but the mixing of the stagnant film produces forced convection at the heat transfer surface.

The kinetic mixing material will help meet current and anticipated environmental regulatory requirements by reducing the use of certain toxic additives and replacing the toxic additives with an environmentally friendly, inert solid, i.e., kinetic mixing material that is both chemically and thermally stable.

The kinetic mixing particles of the invention may be of several types. The particle types are discussed in greater detail below.

### Particle Type I

Particle type I embeds deep into the boundary layer to produce excellent kinetic mixing in both the boundary layer and in the mixing zone. Type I particles increase dispersion of chemical and mineral additives. Type I particles increase fluid flow. The surface area of Type I particles is large compared to the mass of Type I particles. Therefore Type I particles stay in suspension well.

Referring to FIG. 1, shown is expanded perlite that is unprocessed. Perlite is a mineable ore with no known environmental concerns and is readily available on most continents and is only surpassed in abundance by sand. Expanded perlite is produced through thermal expansion process which can be tailored to produce a variety of wall thicknesses of the bubbles. Expanded perlite clearly shows thin wall cellular structure and how it will deform under pressure. In one embodiment, perlite may be used in a raw unprocessed form, which is the most economic form of the material. Perlite has an ability to self-shape under pressure into boundary layer kinetic mixing particles.

Referring to FIG. 2, shown is an image that demonstrates that the expanded perlite particles do not conglomerate and will flow easily among other process particles. Therefore, expanded perlite particles will easily disperse with minimal mixing equipment.

Referring to FIG. 3, shown is an enlarged image of an expanded perlite particle showing a preferred structural shape for processed perlite particles. The particles may be described as having three-dimensional wedge-like sharp blades and points with a variety of sizes. The irregular shape promotes diverse kinetic boundary layer mixing. The expanded Perlite shown in FIG. 3 is extremely lightweight, having a density in the range of 0.1-0.15 g/cm. This allows for minimal fluid velocity to promote rotation of the particle. The bladelike characteristics easily capture the kinetic energy of the fluid flowing over the boundary layer while the jagged bladelike characteristics easily pierce into the boundary layer promoting agitation while maintaining adherence to the surface of the boundary layer. The preferred approximate application size is estimated to be 50μ to 900 nm. This kinetic mixing particle produces dispersion in a variety of fluids have viscosities ranging from high to low. Additionally, the particle is an excellent nucleating agent in foaming processes.

Referring now to FIG. 4, shown is volcanic ash in its natural state. Volcanic ash exhibits similar characteristics to the characteristics of expanded perlite, discussed above, regarding the thin walled cellular structures. Volcanic ash is a naturally formed material that is readily mineable and that can be easily processed into a kinetic mixing material that produces kinetic boundary layer mixing. The volcanic ash material is also deformable, which makes it an ideal candidate for in-line processes to produce the desired shapes either by mixing or pressure application.

Referring now to FIG. 5, shown is a plurality of crushed volcanic ash particles. FIG. 5 illustrates that any crushed particle form tends to produce three-dimensional bladelike characteristics, which will interact in the boundary layer in a similar manner to expanded perlite, discussed above, in its processed formed. This material is larger than the processed perlite making its application more appropriate to higher viscosity materials. The preferred approximate application size is estimated to be between 80μ to 30μ. This material will function similar to the processed perlite materials discussed above.

Referring now to FIGS. 6A-6D, shown is natural zeolite-templated carbon produced at 700 C (FIG. 6A), 800 C (FIG. 6B), 900 C (FIG. 6C), and 1000 C (FIG. 6D). Zeolite is a readily mineable material with small pore sizes that can be processed to produce desired surface characteristics of kinetic mixing material. Processed perlite and crushed volcanic ash have similar boundary layer interaction capabilities. Zeolites have small porosity and can, therefore, produce active kinetic boundary layer mixing particles in the nano range. The preferred approximate application size is estimated to be between 900 nm to 600 nm. The particles are ideal for friction reduction in medium viscosity materials.

Referring now to FIG. 7, shown is a nano porous alumina membrane having a cellular structure that will fracture and create particle characteristics similar to any force material. Material fractures will take place at the thin walls, not at the intersections, thereby producing characteristics similar to the previously discussed materials, which are ideal for boundary layer kinetic mixing particles. The preferred approximate application size is estimated to be between 500 nm to 300 nm. The particle sizes of this material are more appropriately applied to medium to low viscosity fluids.

Referring now to FIG. 8, shown is a pseudoboehmite phase Al₂O₃xH₂O grown over aluminum alloy AA2024-T3. Visible are bladelike characteristics on the surface of processed Perlite. The fracture point of this material is at the thin blade faces between intersections where one or more blades join. Fractures will produce a three-dimensional blade shape similar to a “Y”, “V” or “X” shape or similar combinations of geometric shapes. The preferred approximate application size is estimated to be from 150 nm to 50 nm.

Particle Type II

Particle type II achieves medium penetration into a boundary layer for producing minimal kinetic boundary layer mixing and minimal dispersion capabilities. Type II particles result in minimal enhanced fluid flow improvement and are easily suspended based on the large surface and extremely low mass of Type II particles.

The majority of materials that form hollow spheres can undergo mechanical processing to produce egg shell-like fragment with surface characteristics to promote kinetic boundary layer mixing.

Referring now to FIG. 9, shown is an image of unprocessed hollow spheres of ash. Ash is mineable material that can undergo self-shaping to produce kinetic boundary layer mixing particle characteristics depending on process conditions. The preferred approximate application size is estimated to be 80μ to 20μ prior to self-shaping processes. Self-shaping can be achieved either by mechanical mixing or pressure, either of which produce a crushing effect.

Referring now to FIG. 10, shown are processed hollow spheres of ash. The fractured ash spheres will tumble in a boundary layer similar to a piece of paper on a sidewalk. The slight curve of the material is similar to a piece of egg shell in that the material tends to tumble because of its light weight and slight curvature. Preferred approximate application size is estimated to be between 50 nm to 5 nm. This material will function similar to expanded perlite but it possesses an inferior disbursing capability because its geometric shape does not allow particles to become physically locked into the boundary layer due to the fact that two or more blades produces more resistance and better agitation as a particle tumbles along the boundary layer. This material reduces friction of heavy viscosity materials.

Referring now to FIG. 11, shown are 3M® glass bubbles that can be processed into broken eggshell-like structure to produce surface characteristics to promote kinetic boundary layer mixing. The particles that are similar in performance and application to the ash hollow spheres except that the wall thickness and diameter as well as strength can be tailored based on process conditions and raw material selections. These man-made materials can be used in food grade applications. The preferred approximate application size is estimated to be from 80μ to 5μ prior to self-shaping processes either by mechanical mixing or by pressure that produce a crushing effect.

Referring now to FIG. 12, shown is an SEM photograph of fly ash particles×5000 (FIG. 12A) and zeolite particles×10000 (FIG. 12B). The particles comprise hollow spheres. Fly ash is a common waste product produced by combustion. Fly ash particles are readily available and economically affordable. Zeolite can be mined and made by an inexpensive synthetic process to produce hundreds of thousands of variations. Therefore, desirable characteristics of the structure illustrated by this hollow zeolite sphere can be selected. The zeolite particle shown is a hybrid particle, in that the particle will have surface characteristic similar to processed perlite and the particle retains a semi-curved shape like an egg shell of a crushed hollow sphere. The preferred approximate application size is estimated to be from 5μ to 800 nm prior to self-shaping processes. Self-shaping may be accomplished either by mechanical mixing or by wellbore pressure to produce a crushing effect. The small size of these particles makes the particles ideal for use in medium viscosity materials.

Particle type III

Particle type III result in minimal penetration into a boundary layer. Type III particles result in minimal kinetic mixing in the boundary layer and have excellent dispersion characteristics with both soft chemical and hard mineral additives. Type II particles increase fluid flow and do not suspend well but are easily mixed back into suspension.

Some solid materials have the ability to produce conchordial fracturing to produce surface characteristics to promote kinetic boundary layer mixing.

Referring now to FIGS. 13 and 14, shown are images of recycled glass. Recycled glass is a readily available man-made material that is inexpensive and easily processed into kinetic boundary layer mixing particles. The sharp bladelike characteristics of the particles are produced by conchordial fracturing similar to a variety of other mineable minerals. The bladelike characteristics of these particles are not thin like perlite. The density of the particles is proportional to the solid that is made from. The sharp blades interact with a fluid boundary layer in a manner similar to the interaction of perlite except that the recycled glass particles require a viscous material and a robust flow rate to produce rotation. Processed recycled glass has no static charge. Therefore, recycled glass produces no agglomeration during dispersion. However, because of its high density it can settle out of the fluid easier than other low-density materials. The preferred approximate application sizes are estimated to be between 200μ to 5μ. This material produces good performance in boundary layers of heavy viscosity fluids with high flow rates. This kinetic mixing particle produces dispersion. The smooth surface of the particles reduces friction.

Referring now to FIG. 15, shown is an image of processed red lava volcanic rock particles. Lava is a readily available mineable material. A typical use for lava is for use as landscape rocks in the American Southwest and in California. This material undergoes conchordial fracturing and produces characteristics similar to recycled grass. However, the fractured surfaces possess more surface roughness than the smooth surface of the recycled glass. The surface characteristics produce a slightly more grinding effect coupled with bladelike cutting of a flowing fluid. Therefore, the particles not only tumble, they have an abrasive effect on the fluid stream. The volcanic material disperses semi-hard materials throughout viscous mediums such as fire retardants, titanium, calcium carbonate, dioxide etc. The preferred approximate application sizes are estimated to be between 40μ to 1μ. This material produces good performance in the boundary layer of flowing heavy viscosity materials at high flow rates. This kinetic mixing particle produces dispersion.

Referring now to FIGS. 16A-16D, FIGS. 16A-16C show sand particles that have the ability to fracture, which produces appropriate surface characteristics for kinetic boundary layer mixing particles. The images show particles having similar physical properties to recycled glass, which produces similar benefits. FIGS. 16A, 16B, and 16D have good surface characteristics for interacting with the boundary layer even though they are different. FIG. 16A shows some bladelike characteristics but good surface roughness along edges of the particle to promote boundary layer surface interaction but will require higher velocity flow rates to produce tumbling. FIG. 16B has similar surface characteristics to the surface characteristics of recycled glass as discussed previously. FIG. 16D shows particles having a good surface roughness to promote interaction similar to the interaction of these materials generally. The performance of these particles is similar to the performance of recycled glass. Sand is an abundant material that is mineable and can be processed inexpensively to produce desired fractured shapes in a variety of sizes. Sand is considered environmentally friendly because it is a natural material. The preferred approximate application sizes are estimated to be between 250μ to 5μ. This material produces good performance in the boundary layers of heavy viscosity materials at high flow rates. This kinetic mixing particle produces dispersion. The smooth surface of the particles reduces friction.

Referring now to FIGS. 17A-17F, shown are images of Zeolite Y, A and Silicate-1. The SEM images of films synthesized for 1 h (FIGS. 17A, 17B), 6 h (FIGS. 17C, 17D) and 12 h (FIGS. 17E, 17F) in the bottom part of a synthesis solution at 100 C. These materials can be processed to produce nano sized kinetic boundary layer mixing particles. This material is synthetically grown and is limited in quantity and is, therefore, expensive. All six images, i.e., FIGS. 17A-17F clearly show the ability of this material to produce conchordial fracturing with bladelike structures similar to the structures mentioned above. The preferred approximate application size is estimated to be between 1000 nm to 500 nm. The particle size range of this material makes it useful in medium viscosity fluids.

Referring now to FIG. 18, shown is phosphocalcic hydroxyapatite, formula Ca₁₀(PO₄)₆(OH)₂, forms part of the crystallographic family of apatites, which are isomorphic compounds with the same hexagonal structure. This is the calcium phosphate compound most commonly used for biomaterial. Hydroxyapatite is mainly used for medical applications. The surface characteristics and performance are similar to those of red lava particles, discussed above, but this image shows a better surface roughness than the particle shown in the red lava image.

Particle Type IV

Some solid clustering material have the ability to produce fracturing of the cluster structure to produce individual unique uniform materials that produce surface characteristics to promote kinetic boundary layer mixing.

Referring now to FIGS. 19A and 19B, shown are SEM images of Al foam/zeolite composites after 24 h crystallization tie at different magnifications. FIG. 19A shows an AL form/zeolite strut. FIG. 19B shows MFI agglomerates. The two images that show an inherent structure of this material that will readily fracture upon mechanical processing to produce irregular shaped clusters of the individual uniquely formed particles. The more diverse a material's surface characteristics, the better the material will interact with the sticky nonslip zone of a flowing fluid's boundary layer to produce kinetic boundary layer mixing. This material possesses flowerlike buds with protruding random 90° corners that are sharp and well defined. The corners will promote mechanical agitation of the boundary layer. The particles also have a semi-spherical or cylinder-like shapes that will allow the material to roll or tumble while maintaining contact with the boundary layer due to the diverse surface characteristics. The preferred approximate application size of the particles is estimated to be between 20μ to 1μ. This material could be used in a high viscosity fluid. The surface characteristics will produce excellent dispersion of hardened materials such as fire retardants, zinc oxide, and calcium carbonate. As this material is rolled, the block-like formation acts like miniature hammer mills that chip away at the materials impacting against the boundary layer as fluid flows by.

Referring now to FIGS. 20A and 20B, shown is an SEM image of microcrystalline zeolite Y (FIG. 20A) and an SEM image of nanocrystalline zeolite Y (FIG. 20B). The particles have all the same characteristics on the nano level as those mentioned in the foam/zeolite, above. In FIG. 20A, the main semi-flat particle in the center of the image is approximately 400 nm. In FIG. 20B, the multifaceted dots are less than 100 nm in particle size. Under mechanical processing, these materials can be fractured into diverse kinetic boundary layer mixing particles. The preferred approximate application size is estimated for the cluster material of FIG. 20A to be between 10μ to 400 nm and for cluster material of FIG. 20B to be between 50 nm to 150 nm. Under high mechanical sheer, these clustering materials have the ability to self-shape by fracturing the most resistant particle that is preventing the cluster particle from rolling easily. Due to their dynamic random rotational ability, these cluster materials are excellent for use as friction modifiers.

Referring now to FIG. 21, shown are zinc oxide particles of 50 nm to 150 nm. Zinc oxide is an inexpensive nano powder that can be specialized to be hydrophobic or to be more hydrophilic depending on the desired application. Zinc oxide forms clusters having extremely random shapes. This material works very well due to its resulting random rotational movement in a flowing fluid. The particles have diverse surface characteristics with 90° corners that create bladelike characteristics in diverse shapes. Surface characteristics include protruding arms that are conglomerated together in various shapes such as cylinders, rectangles, cues, Y-shaped particles, X-shaped particles, octagons, pentagon, triangles, diamonds etc. Because these materials are made out of clusters having diverse shapes the materials produce enormous friction reduction because the boundary layer is churned to be as close to turbulent as possible by diverse mechanical mixing while still maintaining a laminar fluid flow.

Particle Type V

Particles of Type V result in medium penetration into the boundary layer. Type V particles create medium kinetic mixing of the boundary layer similar to a leaf rake on dry ground. Type five particles have excellent adhesive forces to the gluey region to the boundary layer, which is required for two-phase boundary layer mixing. Particle Type V produces minimal dispersion of additives, therefore increases fluid flow and will tend to stay in suspension. Some hollow or solid semi-spherical clustering material with aggressive surface morphology, e.g., roughness, groups, striations and hair-like fibers, promote excellent adhesion to the boundary layer with the ability to roll freely and can be used in low viscosity fluids and phase change materials, e.g., liquid to a gas and gas to a liquid. They possess the desired surface characteristics to promote boundary layer kinetic mixing.

Referring now to FIGS. 22A and 22B, shown is a scanning electron micrograph of solid residues (FIG. 22A) and a scanning electron micrograph and energy dispersive spectroscopy (EDS) area analysis of zeolite-P synthesized at 100 C. Unlike the cluster materials discussed in particle type IV, these materials have a spherical shape and a surface roughness that may be created by hair-like materials protruding from the surface of the particles. FIG. 22A shows a particle that possesses good spherical characteristics. A majority of the spheres have surface roughness that is created by small connecting particles similar to sand grains on the surface. FIG. 22B shows a semi-circular particle that has hair-like fibers protruding from the entire surface. These characteristics promote good adhesion to the boundary layer but not excellent adhesion. These materials must roll freely on the surface of the boundary layer to produce minimal mixing to promote kinetic boundary layer mixing in a two-phase system. For example, as a liquid transitions to a gas in a closed system the boundary layer is rapidly thinning. The particles must stay in contact and roll to promote kinetic boundary layer mixing. The material also must have the ability to travel within the gas flow to recycle back into the liquid to function as an active medium in both phases. These particles have a preferred size range of between approximately between 1μ to 5μ (FIG. 22A) and from between approximately 20μ to 40μ (FIG. 22B). They both would work well in a high pressure steam generation system where they would move the stagnant film on the walls of the boiler from conduction toward a convection heat transfer process.

Particle Type VI

Referring now to FIGS. 23A, 23B, and 23C, shown are nanostructured CoOOH hollow spheres that are versatile precursors for various cobalt oxide datives (e.g. CO₃O₄, LiCoO₂) and also possess excellent catalytic activity. CuO is an important transition metal oxide with a narrow bandgap (e.g., 1.2 eV). CuO has been used as a catalyst, a gas sensor, in anode materials for Li ion batteries. CuO has also been used to prepare high temperature superconductors and magnetoresistance materials.

Referring now to FIGS. 25A and 25B, shown is a 2.5 μm uniform plain Al₂O₃ nanospheres (FIG. 25A) and 635 nm uniform plain Al₂O₃ nanospheres having hair-like fibers on the surface.

Referring now to FIG. 26, shown is a computer generated model that shown hair-like fibers that promote boundary layer adhesion so that nano-sized particles will stay in contact with the boundary layer while rolling along the boundary layer and producing kinetic mixing.

### BRIEF DESCRIPTION OF THE DRAWINGS

FIG. 1 is an SEM image of unprocessed expanded perlite.

FIG. 2 is an SEM image of processed perlite at 500× magnification.

FIG. 3 is an SEM image of processed perlite at 2500× magnification.

FIG. 4 is an SEM image of volcanic ash wherein each tick mark equals 100 microns.

FIG. 5 is an SEM image of volcanic ash wherein each tick mark equals 50 microns.

FIG. 6A is an SEM image of natural zeolite-templated carbon produced at 700 C.

FIG. 6B is an SEM image of natural zeolite-templated carbon produced at 800 C.

FIG. 6C is an SEM image of natural zeolite-templated carbon produced at 900 C.

FIG. 6D is an SEM image of natural zeolite-templated carbon produced at 1,000 C.

FIG. 7 is an SEM image of nano porous alumina membrane at 30000× magnification.

FIG. 8 is an SEM image of pseudoboehmite phase Al₂O₃xH₂O grown over aluminum alloy AA2024-T3 at 120,000 magnification.

FIG. 9 is an SEM image of unprocessed hollow ash spheres at 1000× magnification.

FIG. 10 is an SEM image of processed hollow ash spheres at 2500× magnification.

FIG. 11 is an SEM image of 3M® glass bubbles.

FIGS. 12A and 12B are an SEM images of fly ash particles at 5,000× (FIG. 12A) and 10,000× (FIG. 12B) magnification.

FIG. 13 is an SEM image of recycled glass at 500× magnification.

FIG. 14 is an SEM image of recycled glass at 1,000× magnification.

FIG. 15 is an SEM image of processed red volcanic rock at 750× magnification.

FIG. 16A-16D are SEM images of sand particles.

FIG. 17A is an SEM image of zeolite Y, A and silicate 1 synthesized for 1 hour.

FIG. 17B is an SEM image of zeolite Y, A and silicate 1 synthesized for 1 hour.

FIG. 17C is an SEM image of zeolite Y, A and silicate 1 synthesized for 6 hours.

FIG. 17D is an SEM image of zeolite Y, A and silicate 1 synthesized for 6 hours.

FIG. 17E is an SEM image of zeolite Y, A and silicate 1 synthesized for 12 hours.

FIG. 17F is an SEM image of zeolite Y, A and silicate 1 synthesized for 12 hours.

FIG. 18 is an SEM image of phosphocalcic hydroxyapatite.

FIG. 19A is an SEM image of Al MFI agglomerates.

FIG. 19B is an SEM image of Al MFI agglomerates.

FIG. 20A is an SEM image of microcrystalline zeolite Y at 20 kx magnification.

FIG. 20B is an SEM image of microcrystalline zeolite Y at 100 kx magnification.

FIG. 21 is an SEM image of ZnO, 50˜150 nm.

FIG. 22A is an SEM image of solid residues of semi-spherical clustering material.

FIG. 22B is an SEM image of zeolite-P synthesized at 100° C.

FIG. 23A is an SEM image of nanostructured CoOOH hollow spheres.

FIG. 23B is an SEM image of CuO.

FIG. 23C is an SEM image of CuO.

FIG. 24A is an SEM image of fused ash at 1.5N at 100° C.

FIG. 24B is an SEM image of fused ash at 1.5N at 100° C. 6 hours showing unnamed zeolite.

FIG. 24C is an SEM image of fused ash at 1.5N at 100° C. 24 hours showing cubic zeolite.

FIG. 24D is an SEM image of fused ash at 1.5N at 100° C. 72 hours showing unnamed zeolite and Gibbsite large crystal.

FIG. 25A is an SEM image of 2.5 um uniform plain Al₂O₃ nanospheres.

FIG. 25B is an SEM image of 635 nm uniform plain Al₂O₃ nanospheres.

FIG. 26 is a computer-generated model showing hair-like fibers of CoOOH

FIG. 27 shows two samples of rigid PVC with the same pigment loading in both samples wherein one sample includes kinetic boundary layer mixing particles.

FIG. 28 shows two samples of polycarbonate with the same pigment loading in both samples wherein one sample includes kinetic boundary layer mixing particles.

FIG. 29 shows a rigid PVC with ABS spots.

FIG. 30 shows PVC and ABS mixed together.

FIG. 31 shows a photograph comparison of dispersing capability in paint with and without the addition of Perlite.

FIG. 32 shows test results where a paint with no additive was applied with airless spray equipment at 18 passes (bottom) and 20 passes (top).

FIG. 33 shows test results when a paint with additive was applied with airless spray equipment at 30 passes.

FIG. 34 shows test results when a paint with an additive was applied with airless spray equipment at 19 passes.

FIG. 35 is a table reporting the results of an atomization test.

FIG. 36 shows a base polypropylene foam with direct gas injection, no additive, wherein the cells size is 163 micron.

FIG. 37 shows a polypropylene foam with 4.8% additive of 27 micron expanded perlite with a cell size of 45 microns.

FIG. 38 shows a test sample wherein green reacted epoxy with and without kinetic mixing particles were mixed with yellow reacted epoxy with and without kinetic mixing particles, respectively. The mixed sample with the kinetic mixing particle achieved superior mixing as evidence by the larger blue area.

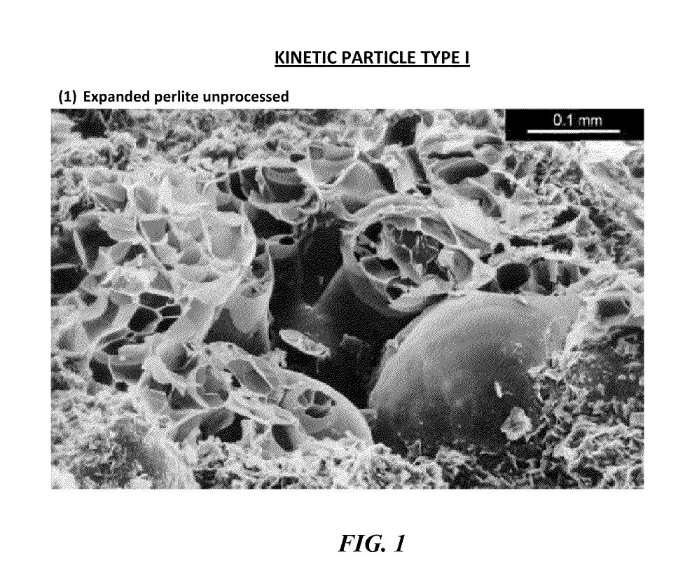

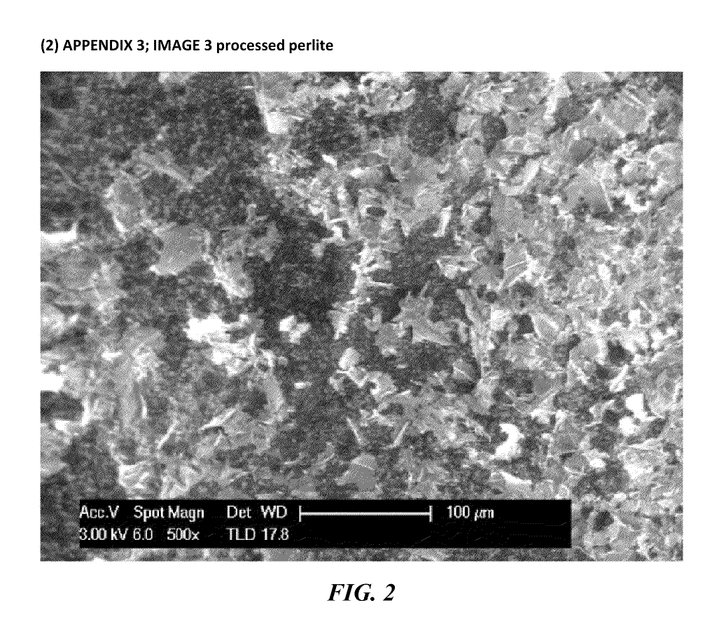

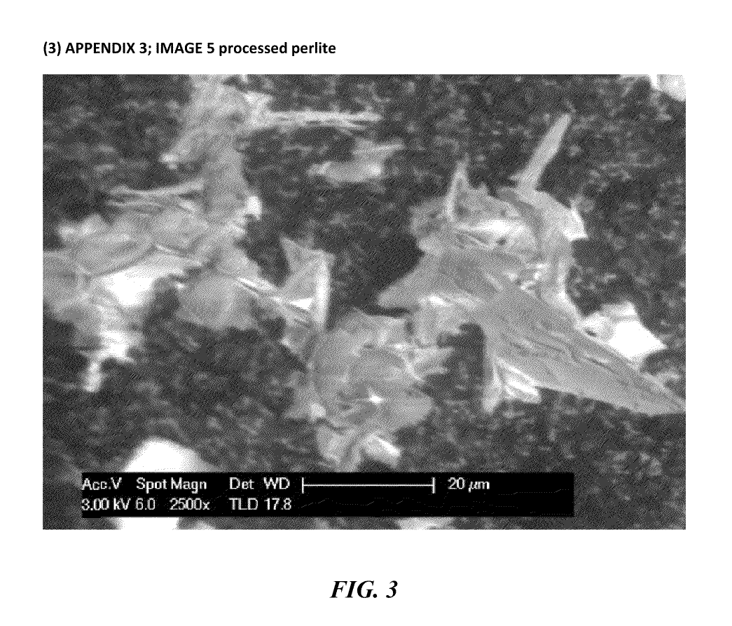

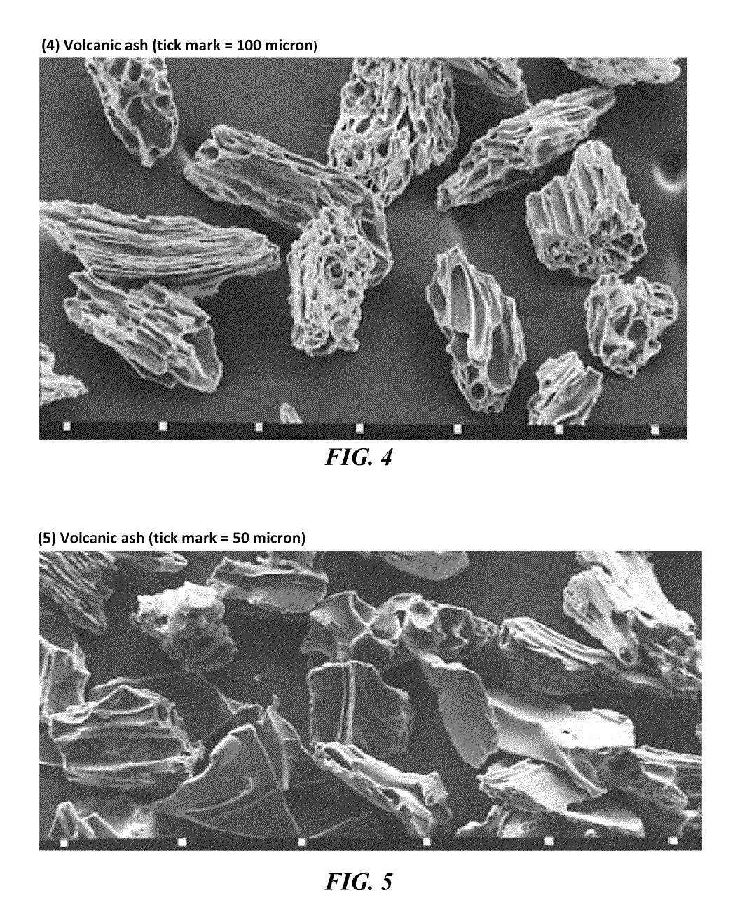

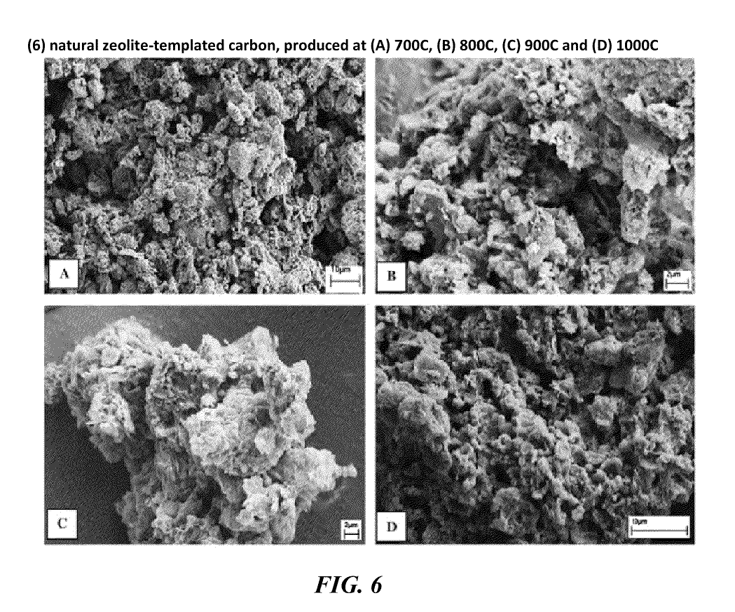

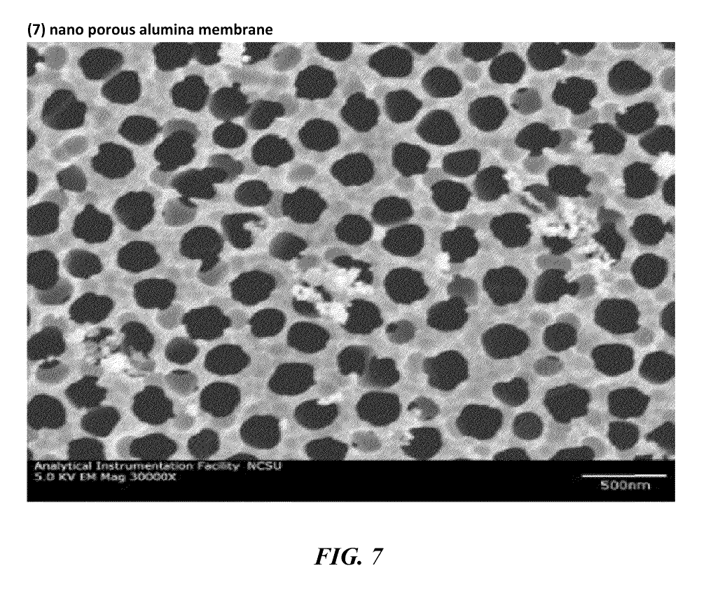

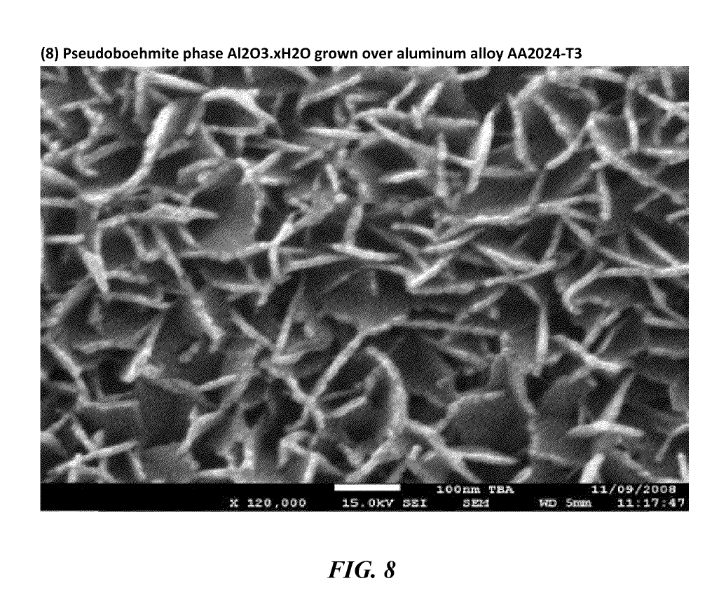

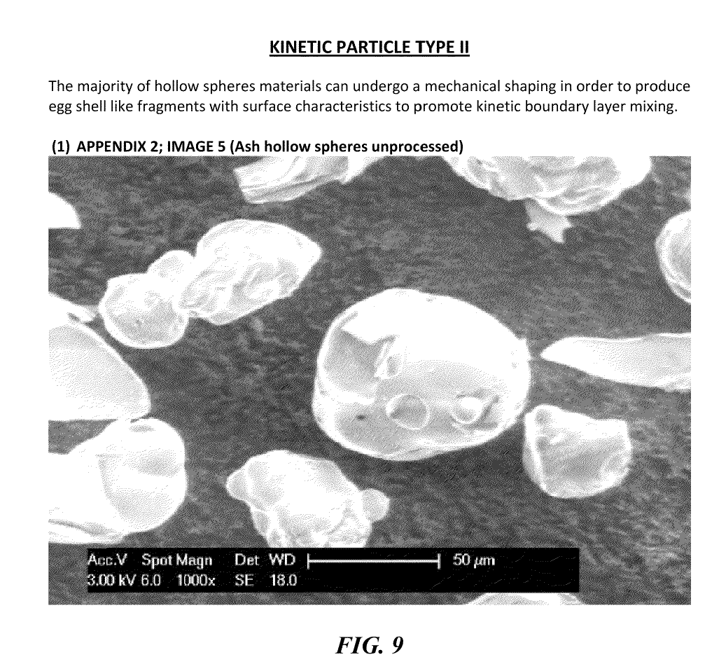

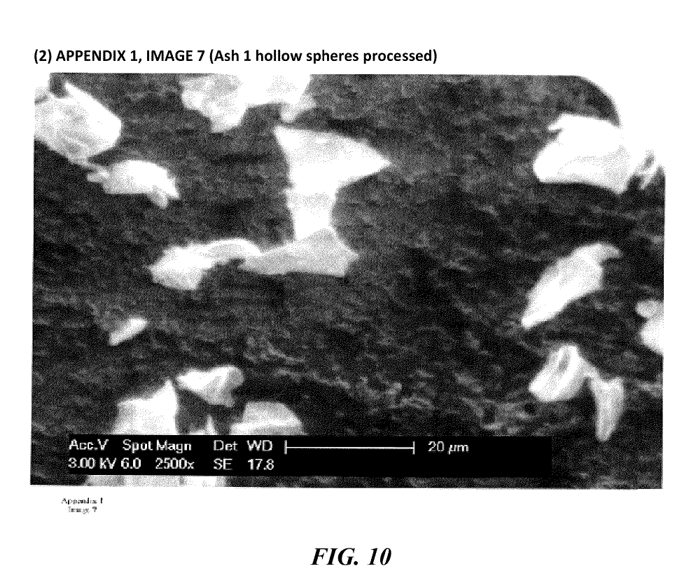

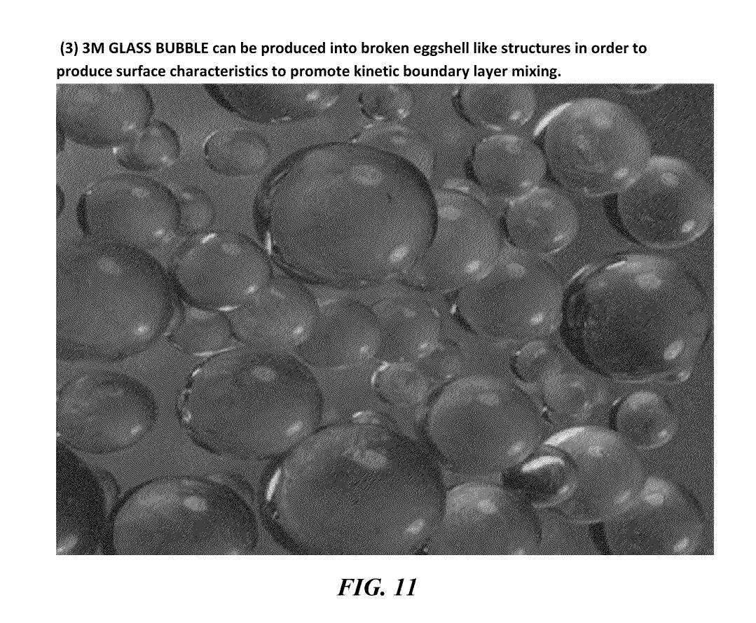

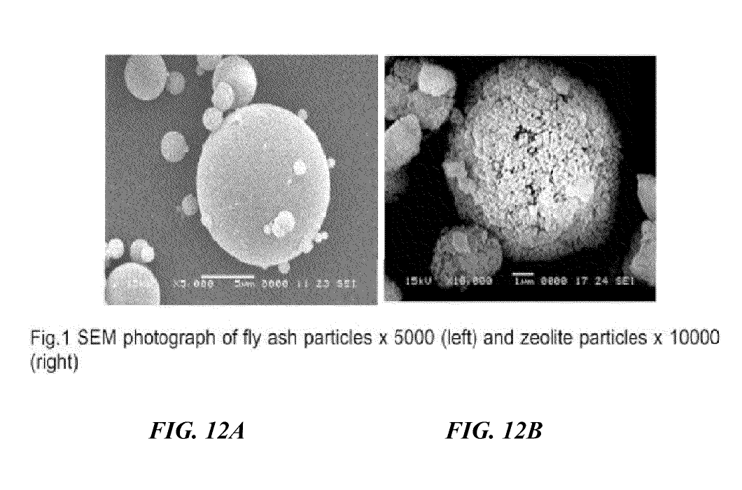

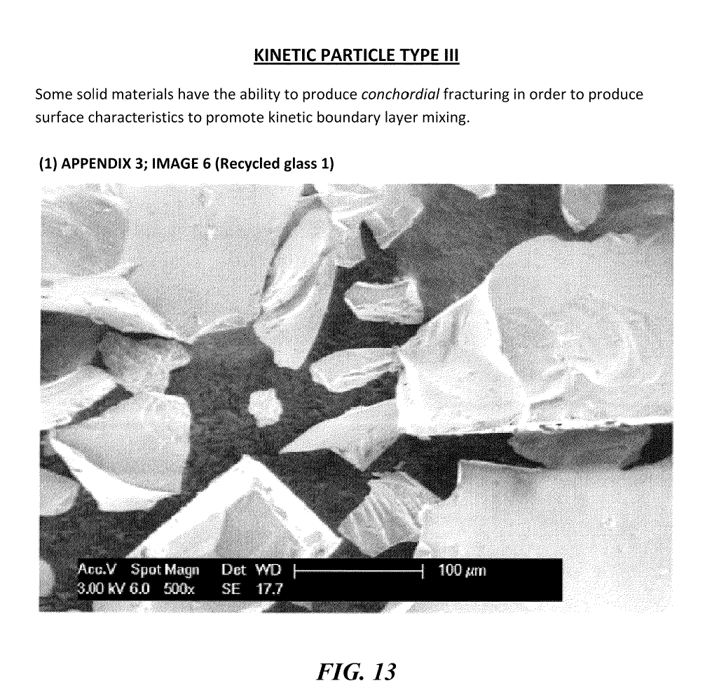

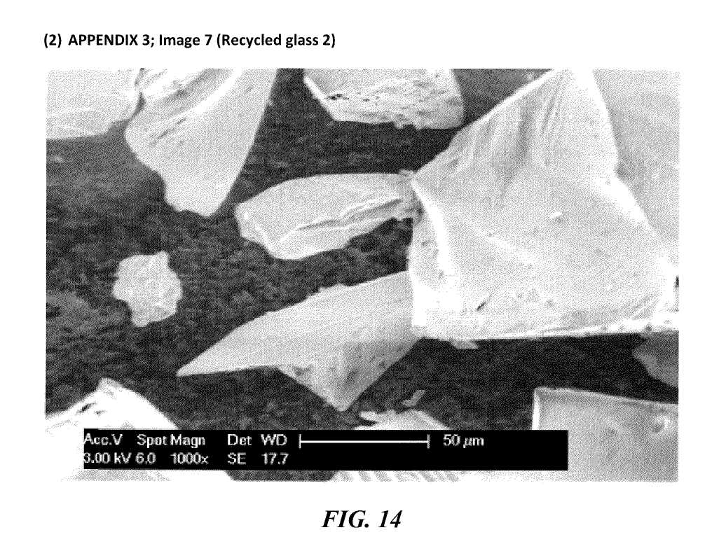

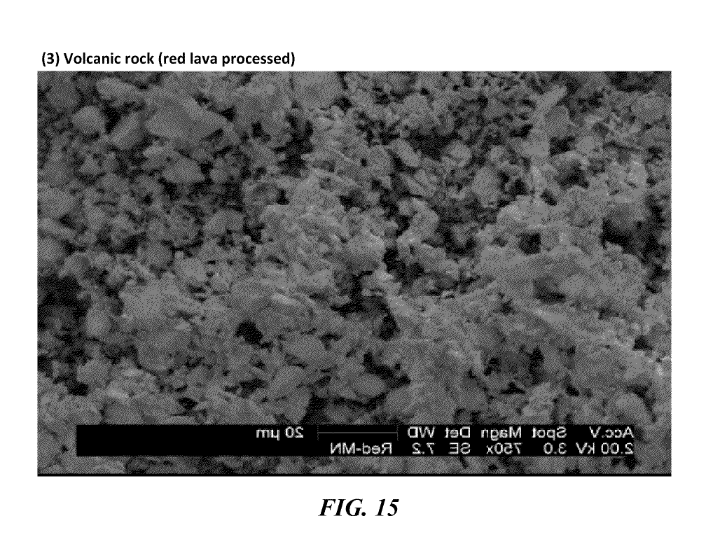

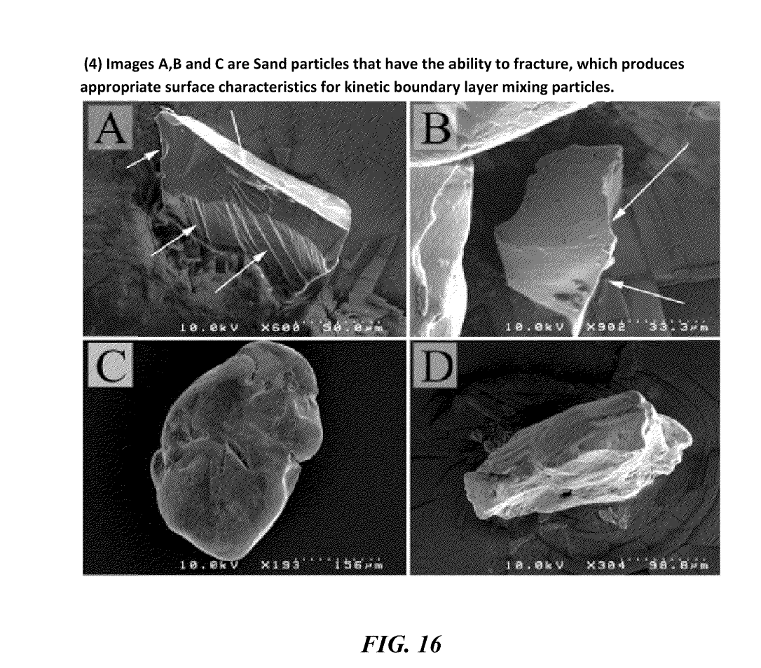

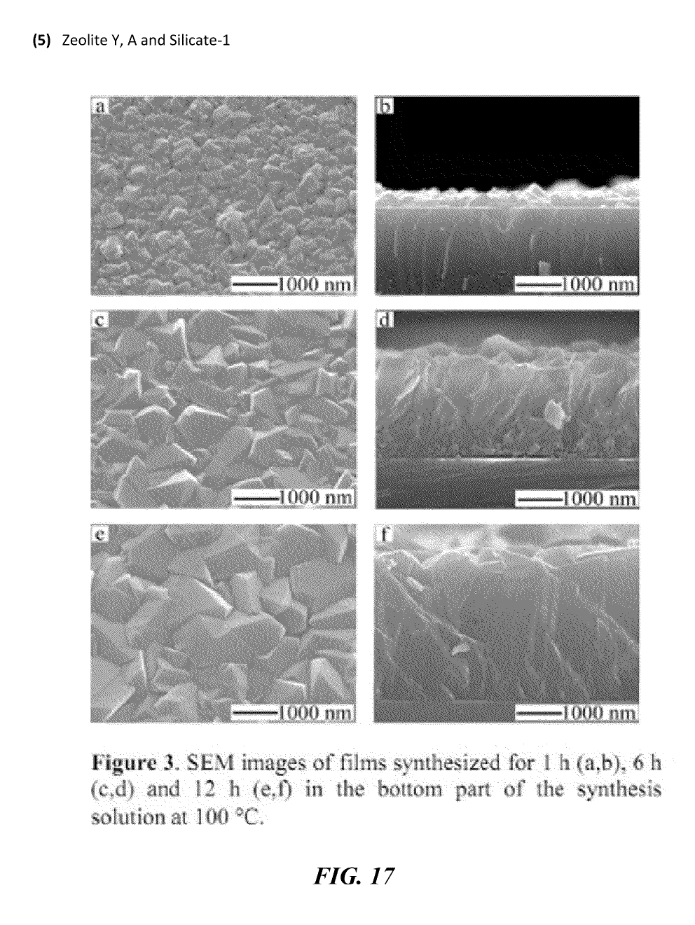

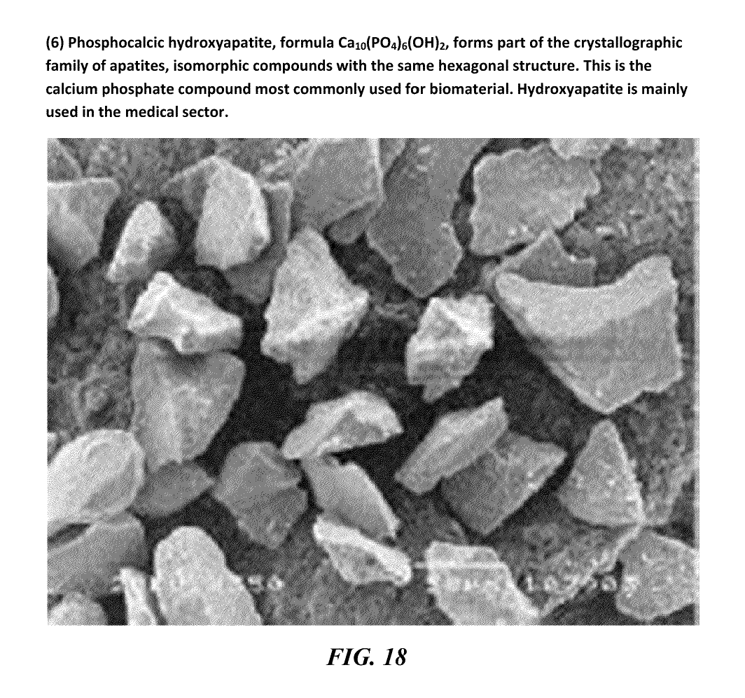

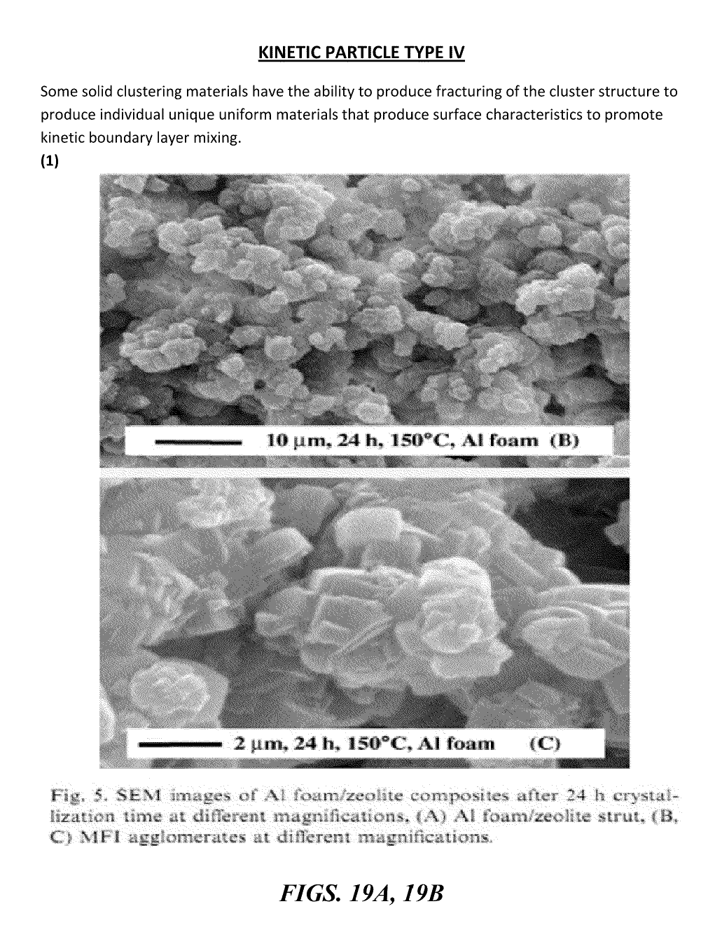

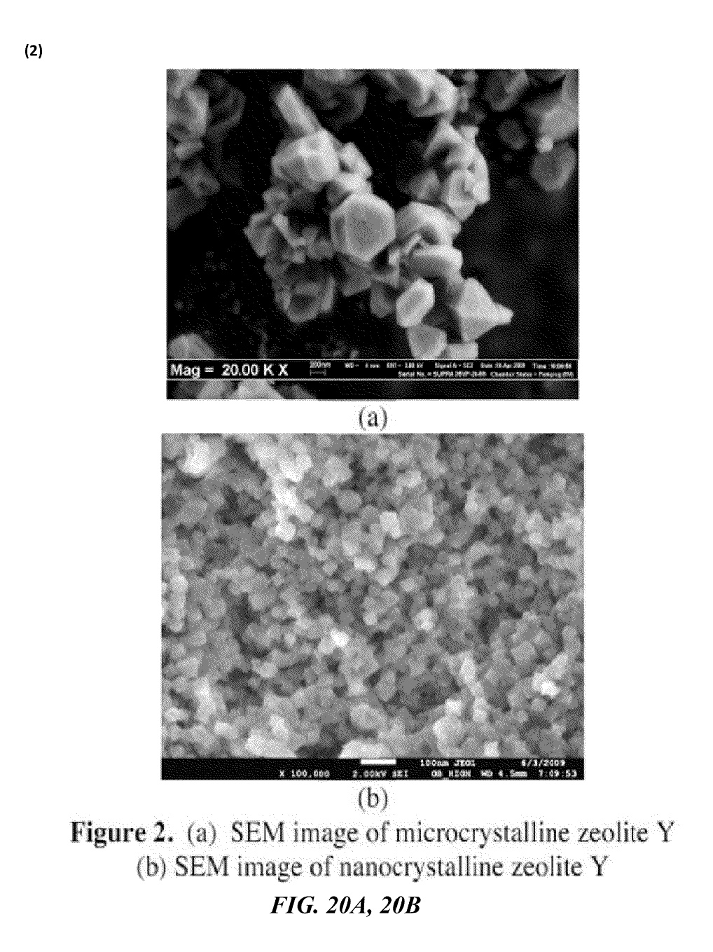

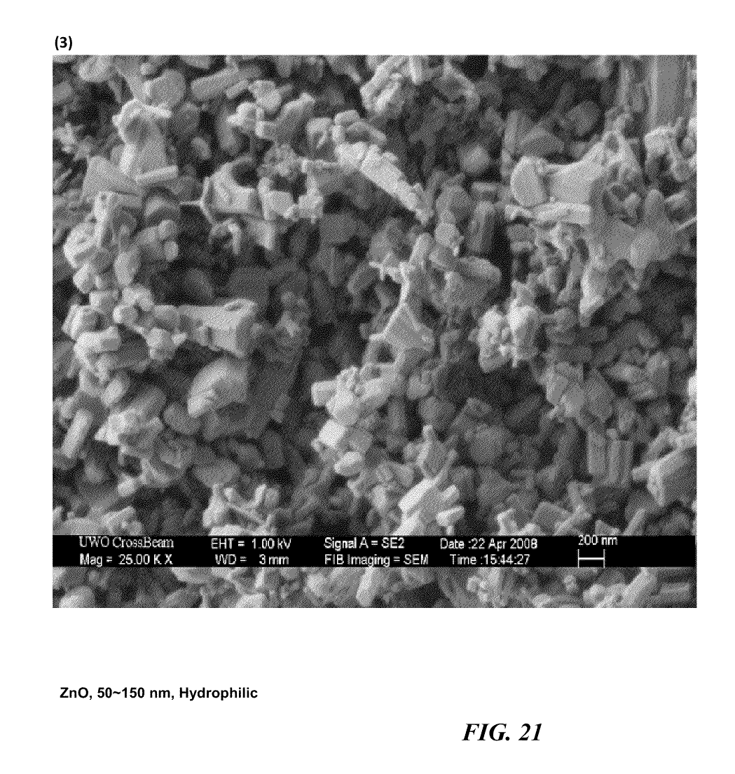

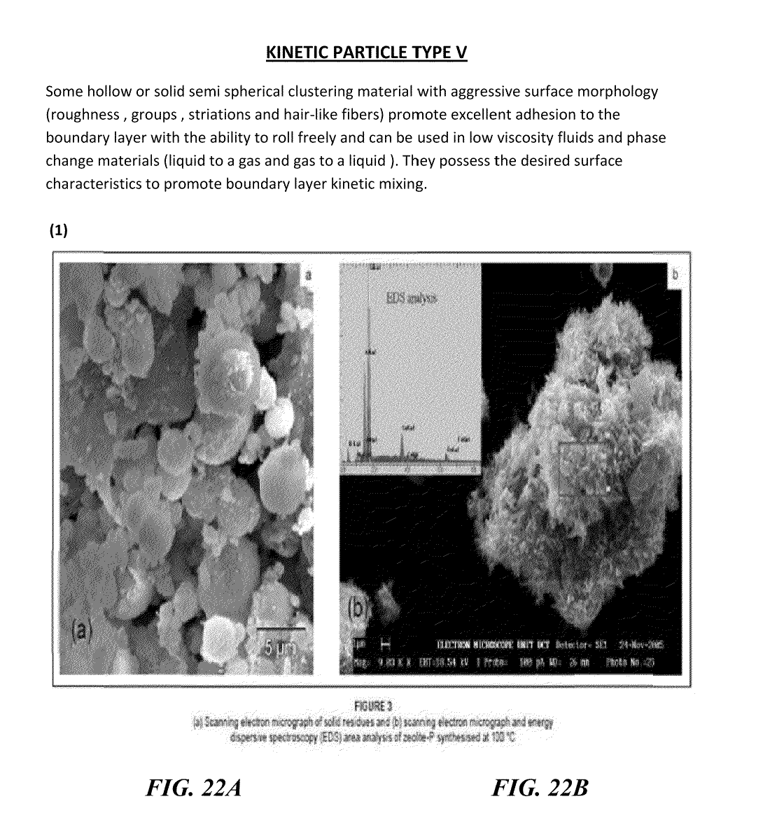

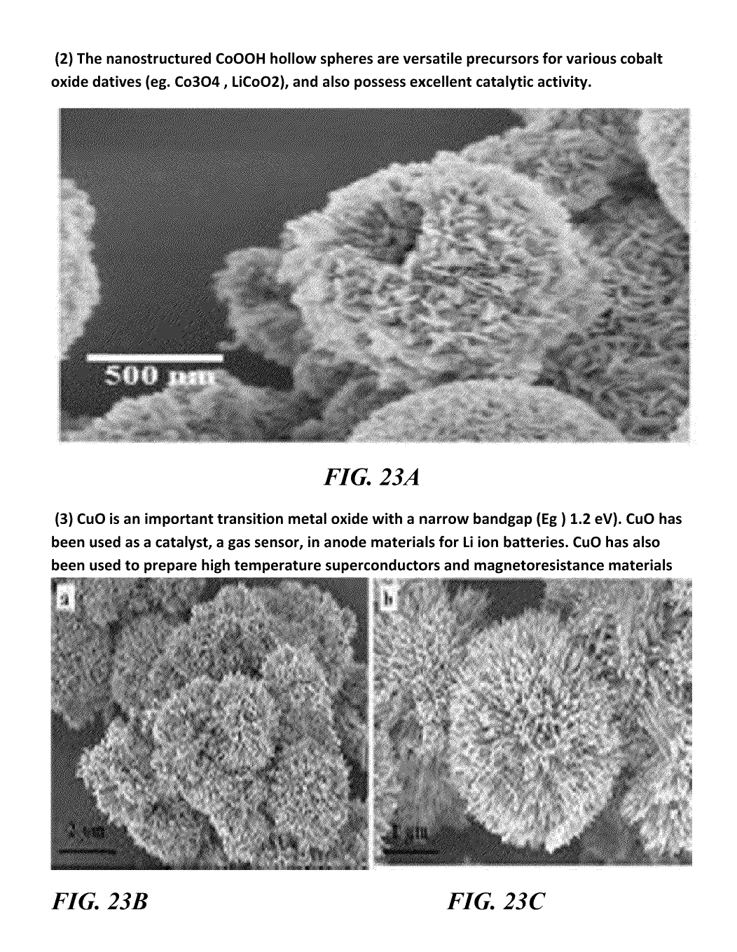

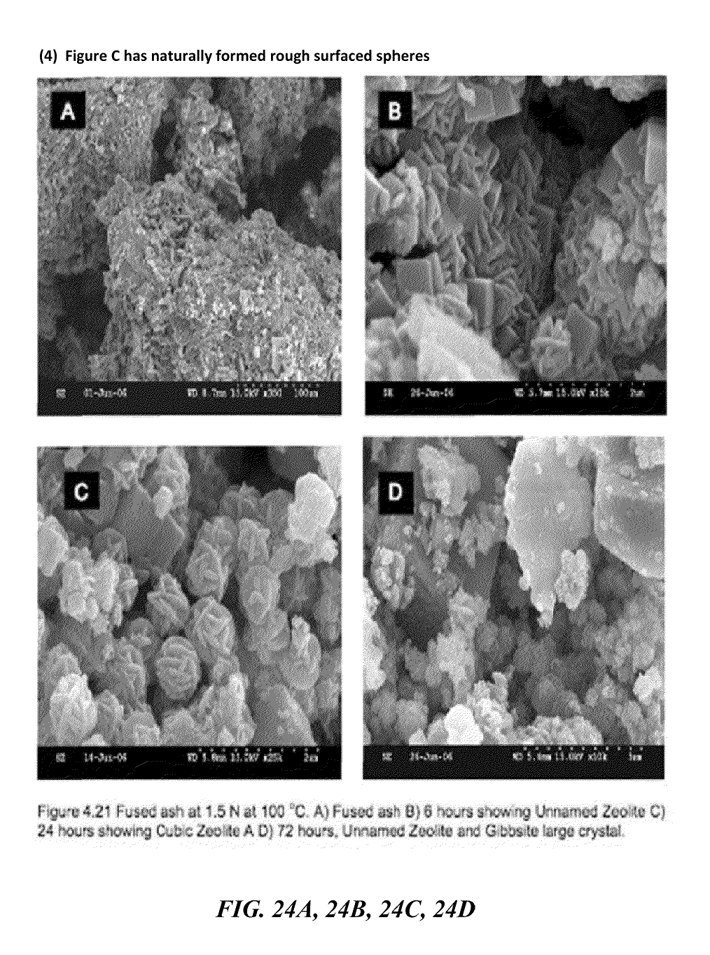

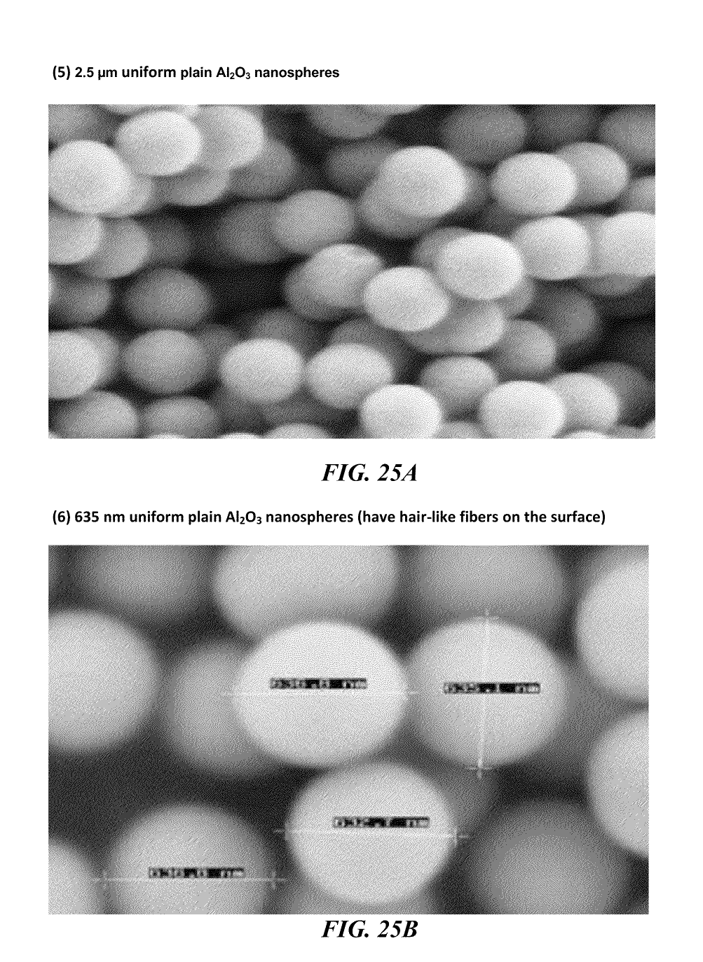

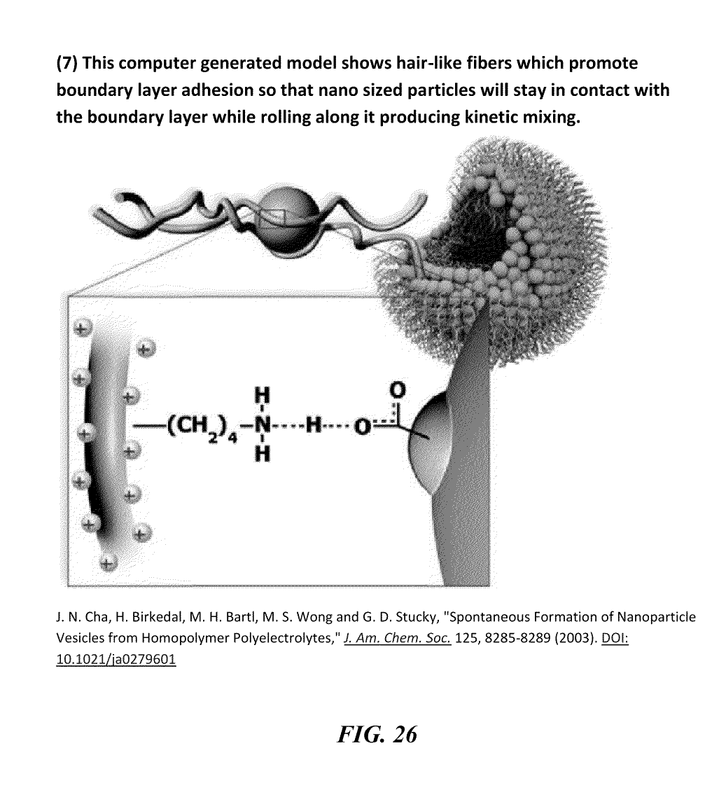

### DETAILED DESCRIPTION OF THE PREFERRED EMBODIMENTS

The present invention utilizes inert micro and anno sized structural particles, i.e., kinetic mixing particles, to improve adhesion of paint to surfaces and to improve an ability of paint to flow, i.e., to improve surface wetting ability. Additionally, the invention improves suspension of additives, improves dispersion of additives and improves paint durability, e.g., color shift caused by fading, weatherability and mechanical toughness.

With regard to fluid dynamics, the boundary layer of a flowing fluid has always been considered fixed and immovable. In the laminar region the boundary layer creates a steady form of resistance to fluid flow. The invention relates to the addition of kinetic mixing particles such as those described in U.S. patent application Ser. No. 12/412,357, entitled, “STRUCTURALLY ENHANCED PLASTICS WITH FILLER REINFORCEMENTS”. U.S. patent application Ser. No. 12/412,357 is hereby incorporated by reference. The addition of kinetic mixing particles kinetically will move the boundary layer when the fluid is moving, which promotes flow and decreases film drag. The reduction of drag is similar to comparing static friction to the kinetic friction of a moving body and applying these concepts to a fluid flow. By adding the kinetic mixing particles of the invention, the boundary layer can be moved kinetically, which will reduce drag and increase flow. If the fluid is not moving, the inert structural particle, i.e., the kinetic mixing particle will act like dynamic reinforcing structural filler.

1. Adhesion to Surfaces

The ability for a material, such as a binder or adhesive, to mechanically or chemically adhere to a surface is a function of surface interaction and chemical attraction. Typically, the rougher a surface, the better the adhesion of a binder, but the harder it is for the material to adequately flow into cracks and crevices of the surface. The addition of kinetic mixing particles helps the material being applied to flow better and more evenly over rough surfaces, whether the material is a paint, coating or adhesive, because the kinetic mixing particles mechanically move the boundary layer when the material, i.e., the polymer, is moving over a surface.

Extremely smooth surfaces also produce adhesion challenges. When the inert structural particle, i.e., the kinetic mixing particle, is rolling or tumbling in the boundary layer of the polymer, the motion of the kinetic mixing particle promotes improved surface-to-binder interaction and results in a mild scrubbing of the surface as the boundary layer of the binder or fluid moves over the smooth surface, thereby enhancing adhesion.

2. Ability to Flow (Surface Wetting Ability)

Typically, when solids are added to fluids, the solids reduce an ability of the fluid to flow. Surface wetting capability is a function of the viscosity of the fluid and of chemical interaction of the fluid with the surface. The addition of kinetic mixing particles changes surface-to-surface interaction to create better contact with the substrate or surface and to create better fluid flow throughout the fluid. For example, paint, coatings or adhesives typically use surface tension modifiers to increase the wettability of polymers. The addition of surface tension modifiers has a negative effect in many polymer by lowering the adhesive strength, reducing the cross-linking ability of the polymer, and, in the case of paint, the addition of surface tension modifiers increases sagging and runs of the paint on coated surfaces. By using a kinetic mixing particle to lower the surface tension, which is caused by the boundary layer stagnant film, the addition of kinetic mixing particles will remove all of the previous mentioned surface tension modifiers negative effects. The addition of kinetic mixing particles promotes better surface adhesion by increasing fluid mobility of the boundary layer. The kinetic mixing particles are structural solids, which increase mechanical strength. The kinetic mixing particles do not chemically restrict polymer cross-linking and, if it used in a paint, will reduce sagging and running of coated surfaces

The addition of kinetic mixing particles will allow viscous fluids the ability to produce thinner coatings and to better wet a surface. The addition of kinetic mixing particles is counterintuitive compared to current wetting additives that usually lower the viscosity of the fluid through the use of surface tension modifiers.

3. Suspension of Additives

The more viscous the polymer the better the suspension of additives by preventing the additives from settling out of the polymer. However, a higher viscosity polymer suffers from the reduction of desirable fluid flow properties, the reduction of wettability and the reduction of adhesion due to poor surface interaction to the substrate. Type (I) kinetic mixing particles are typically lightweight with an average density of 0.15-0.5 g/cm and a high aspect ratio of 0.7 and higher, which can increase thickening of the fluid body of the polymer similar to increasing the viscosity of the polymer. However, in contrast to increasing the viscosity, thickening of the polymer by the addition of kinetic mixing particles will improve fluid flow properties, wetability and adhesion to a surface by promoting better surface interaction.

4. Dispersion of Additives

Environmental regulations over the past 20 years have pushed paints, adhesives as well as composite manufacturers to use higher solid contents, thereby lowering the use volatile organic compounds that contribute to poor air quality. New paint formulations have higher viscosities, which makes homogeneous dispersion of additives difficult. The kinetic mixing particle technology of the invention mechanically mixes the chemical additives throughout the polymer on a micron and nano level. For example, a typical household paint is usually mechanically stirred with a paint stick or a paddle mixer powered by a drill to disperse additives prior to application of the paint. The additives are stirred into the binder through fluid motion. However, hard-to-mix areas exist along the walls and bottom of a paint can. The hard-to-mix areas are usually comprised of stagnant film layers that behave similar to a boundary layer. The addition of kinetic mixing particles produces mechanical kinetic stirring in the stagnant regions, thereby promoting film transfer from the wall and from the bottom of the container to the main mixing area, which enhances dispersion of trapped additives.

5. Durability

“Durability” from an aesthetic point of view relates to color shift, fading, weathering and scratch/marring resistance. From a mechanical point of view, durability relates to adhesion, hardness, flexibility, chemical resistance, water sorption and impact resistance etc. Whether durability is good is directly affected by dispersion and suspension of additives such as pigments, UV stabilizers, fungicides, biocides, coupling agents, surface tension modifiers, plasticizers and hardened fillers for scratch protection/mar resistance etc. If additives are not disbursed throughout the polymer to produce a homogeneous mixture there will be regions in the polymer that will produce durability failures. The addition of kinetic boundary layer mixing particle into polymers converts stagnant mixing zones into dynamic dispersion mixing zones, which promotes rapid homogeneous dispersion of additives. Scratch Ingmar resistance characteristics of polymers are usually accomplished by incorporating hard particles such as sand, glass or ceramic spheres and a variety of other hard minerals to protect the polymer. The incorporation of these hardened particles into a softer polymer increases durability by lowering mechanical abrasion of the polymer by applying the abrasion to hardened particle. Take, for example, a type (I) kinetic mixing particle made from expanded perlite with a Mohs scale hardness of 5.5 (equivalent to a high-quality steel knife blade). This kinetic mixing particle will increase the mar and scratch resistance by being incorporated into the polymer.

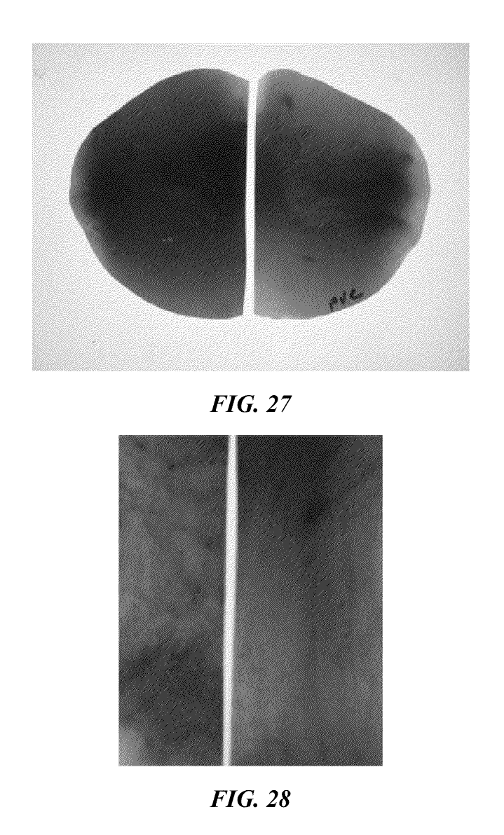

The kinetic boundary layer mixing technology has excellent dispersion capabilities illustrated by FIGS. 27 and 28 in viscosity materials such as thermoplastics in a high shear mixing environment.

FIG. 27 shows a rigid PVC with the same pigment loading in both samples. It can clearly be seen that left sample having the kinetic boundary layer mixing particles therein is dispersed better.

FIG. 28 shows polycarbonate with the same pigment loading in both samples. It can clearly be seen that the one that the sample on the right includes the kinetic boundary layer mixing particles and is dispersed better.

FIGS. 27 and 28 clearly illustrate the benefits of kinetic boundary layer mixing particles in relationship to dispersion. The improved dispersion properties allows hydraulic fracturing fluids to have less additives because the presence of kinetic mixing fluid disburses the additives better, thereby producing the same beneficial properties of an additive.

Mixing and Blending of Dissimilar Materials

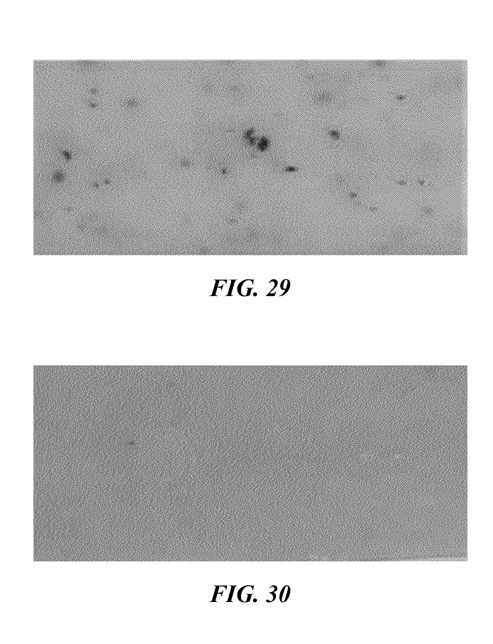

FIG. 29 shows two images. Image 1 shows rigid PVC with ABS spots. These two materials, even under high shear conditions chemically do not want to mix or blend together.

Image 2 of FIG. 30 shows the effect the adding kinetic boundary layer mixing particles on dissimilar hard to mix materials. In the extruder, the PVC and ABS mixed together, which resulted in the ABS acting like a black pigment.

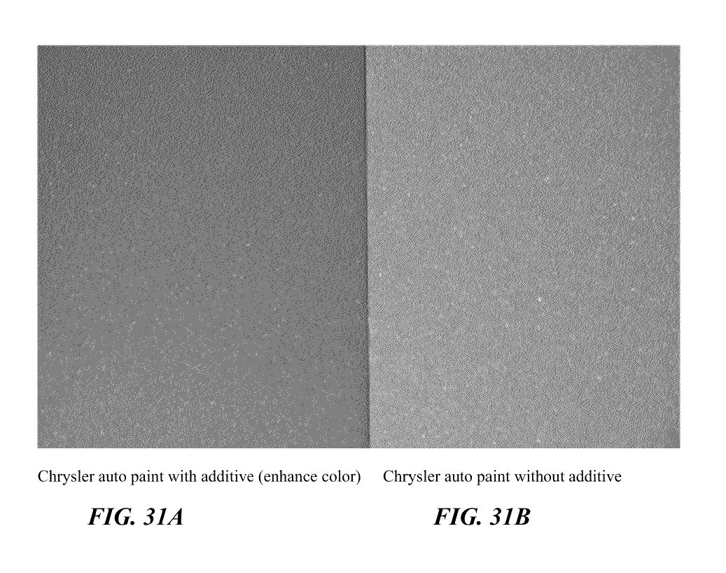

FIGS. 31A and 31B show enhanced dispersing capability of pigments in a Chrysler factory color automotive paint. Both spray samples started with the same premixed Chrysler, PB3 Calcdonia Blue, Series: 293 99384 automotive paint. The sample on the left (FIG. 31A) had a type (I) kinetic boundary layer mixing particle made from expanded perlite added in. The kinetic mixing particle is white in color and was added in at 1% by mass. The sample on the right (FIG. 31B) is the standard factory color. It is clear to see that the sample on the left has a darker, as well as richer, color than the sample on the right. This experiment shows that pigment color can be enhanced by mixing nano and micron particles in the boundary layer of a paint. The improved dispersion of pigments is easy to see. However, other additives are also being dispersed better, to produce a more homogenous mixture, even though the other improved dispersal cannot be seen throughout the polymer.

Typically, additives in polymers are used to promote durability. However, in the case of fire retardants, fillers, defoamers, surface tension modifiers and biocides etc., fillers often have a negative effect on the polymer, which produces fatigue throughout the cross-linked polymer system. The addition of kinetic mixing particles does more than improve mixing. The addition of kinetic mixing particles mechanically reduces the size of additives, which produces better interaction in the polymer matrix. Therefore, by reducing the size of additives and improving dispersion, the amount of additives can be reduced. For example, as can be seen in FIG. 49, the automotive paint became darker in color because of pigment particles that were mechanically processed into smaller particle sizes and dispersed more homogeneously throughout the paint. This homogenous mixing characteristic increases cross-linking strength of the polymer by reducing the amount of additives needed to produce the desired result.

Densification of Polymers

Small inclusions and/or porosity in a polymer can be caused by mechanical agitation during mixing or application. The micron-sized inclusions may be bubbles that have become trapped in the polymer or the inclusions may be small tube-like structures caused by solvents that escape from the polymer during curing. Small inclusions in a cured polymer weaken the ability of the polymer to withstand environmental degradation. For example, repeated freeze-thaw cycles propagate micro cracks throughout the polymer and eventually cause substrate adhesion failure. Micro-cracking throughout the polymer accelerates rapidly because the micro-inclusions promote cracking between themselves upon impact, significantly reducing the impact resistance of the polymer. Micro-inclusions in elastomeric polymers result accelerated wear of the material due to normal abrasion and the reduction of surface adhesion due to micro-inclusions.

Polymer formulators, who are skilled in the art of densifying polymers, usually add surface tension modifiers to promote a lower surface energy to facilitate the escape of inclusions, such as bubbles. The addition of the kinetic mixing particles of the invention allows bubbles to escape by mechanical kinetic movement. Additionally, the addition of kinetic mixing particles strengthens the overall polymer with a structural material. The kinetic mixing particles of the invention produce mechanical perforations through the polymer during kinetic rotation, which allows venting of bubbles to escape the polymer. The three-dimensional geometric structures of the kinetic mixing particles also possess the ability perforate the bubbles, thereby acting like a mechanical defoaming agent as well. Therefore, the addition of the kinetic mixing particles improves the densification of polymers through use of a mechanical structural additive, which increases the durability of the polymer.

Application Methods for Paint, Coatings and Adhesives

Paints are typically applied via brush, roller or automated systems. The addition of kinetic mixing particles to a paint formulation will provide advantages regardless of the application method.

For example, when paint is applied via a brush the kinetic mixing particles become activated with each brush stroke. Each brushstroke produces a velocity profile in the direction of the brushstroke resulting in kinetic movement of the boundary layer. The result is increased adhesion to surfaces, increased surface wetting, improvement of suspension of additives and improvement of dispersion of additives. Since the addition of kinetic mixing particles helps promote flow when fluid is in motion, a better thin-film coating is provided than is possible with traditional paints, coatings and adhesives.

When paint is applied via roller or automated roller systems, the kinetic mixing particles are activated during contact of the roller to the surface, which promotes kinetic boundary layer movement. The addition of kinetic mixing particles promotes better surface coverage on complex surfaces, such as textured drywall, because the velocity of a paint roller acting on the fluid perpendicular to a surface promotes boundary layer thinning which improves flow and reduces pinhole effects caused by bubble formation in the paint over complex surfaces. This results in improved adhesion to surfaces, improved surface wetting, improved suspension of additives and improved dispersion of additives. In the case of industrial automated rolling systems, fluids with added kinetic mixing particles will flow more evenly regardless of the surface variations. In hot glue applications, such as for use with laminate flooring, hot glue having kinetic mixing particles added thereto will have better surface adhesion. Surface adhesion is promoted by kinetic movement in the boundary layer upon application of pressure rollers on a laminate surface during a final adhesion step.

Spray Testing

Below is a description of laser particle atomization characteristics for water and paint. The conclusion is that the addition of kinetic mixing material did not affect atomization of water or paint when expanded perlite was used as the kinetic mixing material.

Most commercial painters use airless spray equipment to apply architectural paints such as acrylics (water-based), enamels (oil-based) and lacquer (solvent-based). There are many types of architectural paints used for a variety of reasons. The biggest challenge related to spraying any coating avoiding applying too much paint. The application of too much paint creates runs. The application of too little paint promotes inconsistent coverage. Testing was conducted to focus on an ability of kinetic boundary layer mixing additives to apply more paint to a given surface and to avoid paint runs. The testing utilized architecture acrylic paint because the paint is water-based and the most environmentally friendly paint which comprises 80% of the United States architectural market.

Experiment #1

The paint tested was Sherwin® Super Paint, Interior, one coat coverage, Lifetime Warranty, Extra White: 6500-41361, Satin finish having a density of 10.91 lb/gal.

The kinetic mixing particle additive was added at 1.0% by mass. The kinetic mixing particle was Type (I) kinetic boundary layer mixing particle made from expanded perlite having an average particle size of 10μ. The Type I kinetic boundary layer mixing particle was chosen because of its light weight and bladelike characteristics, which mixes easily into fluids and creates maximum agitation of the boundary layer. Additionally, Type I kinetic mixing material has the greatest mechanical holding strength to prevent paint from running.

A first and a second paint sample were provided in 1 gallon cans. Each were mechanically shaken in a paint machine for 5 minutes. Additionally, both 1 gallon paint samples were mechanically mixed using a cordless drill at 1,500 rpm with a 1 gallon metal two blade mechanical mixer made by Warner Mfg. (Manufacturer's part # 447) for 10 minutes prior to spray application. The kinetic boundary layer mixing particles were incorporated into the paint using only the mechanical mixing with the cordless drill prior to being spray application.

Observation with Mechanical Mixer:

A) Vortex depth: The mechanical mixing system, i.e., the two blade mixer attached to the drill, was placed in the center of the 1 gallon paint can and was then slowly lowered into the paint at the same rpm until the vortex collapsed. The paint with the 1% kinetic boundary layer mixing particle added thereto allowed a 70% deeper vortex to be formed before collapsing than the paint without the kinetic mixing particles. The vortex depth is a function of fluid velocity related to surface drag of the paint rotating inside the can. The faster the fluid rotates, the deeper the vortex. The drag is caused by cohesive forces of the acrylic paint interacting with the boundary layer, which restricts fluid movement.

The addition of kinetic boundary layer mixing particles reduces the coefficient of friction caused by the boundary layer. The kinetic mixing particles are activated by the kinetic energy applied through centrifugal forces of the paint pushing against the wall of the can during rotation. These forces cause the particles to rotate in the boundary layer of the flowing paint, which converts the coefficient of drag from static to kinetic, thereby increasing the fluid velocity and depth of the vortex.

B) Bubble formation: Mechanical agitation was administered to both paint samples, i.e., to the sample with and without kinetic boundary layer mixing particles, for the same period of time. After the mechanical agitation, the paint with the kinetic boundary layer mixing particles had less than 5% of its surface covered with bubbles. The paint without the kinetic mixing particle additive had 70% of the surface covered with bubbles. Each of the 2 gallon paint samples were then allowed to set for 5 min after mechanical mixing. The paint sample having the kinetic boundary layer mixing additive had only a few bubbles left on the surface. The paint sample without the additive still had more than 50% the surface covered with bubbles.

It is believed that the kinetic boundary layer mixing particles, with their bladelike characteristics, were perforating the bubbles in the paint sample with the kinetic mixing particles added thereto. Therefore, the paint sample was degassed and densified by mechanical means.

Equipment:
Airless sprayer manufacture: AIRLESSCO, model: LP540
Spray gun manufacture: ASM, 300-Series
Spray tip manufacturing: AIRLESSCO, model: 517, type: 10 inch fan, orifice size: 0.017 inches
Spray surface: drywall, type: ½ inch Green board

Equipment Set Up
Airless spray equipment set at 2500 psi
Spray tip distance: 20 inches from surface perpendicular
Single pass with 10 seconds delay between passes

The paint was applied on drywall in direct sunlight at 90° F. and 70% humidity.

Test Results

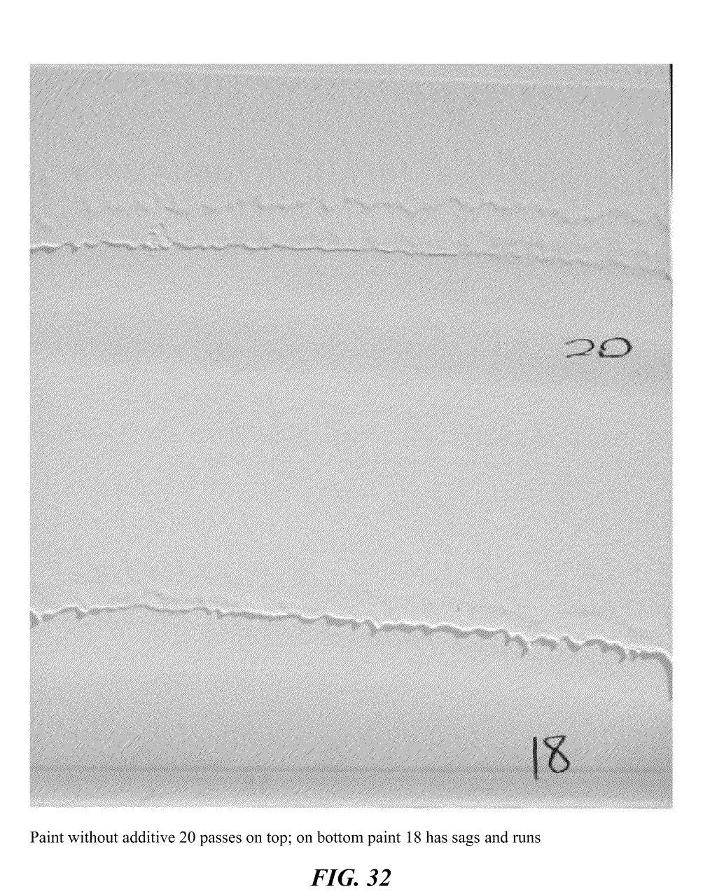

The paint sample having no additive: the paint sagged and ran at 20 and 18 passes; see FIG. 32.

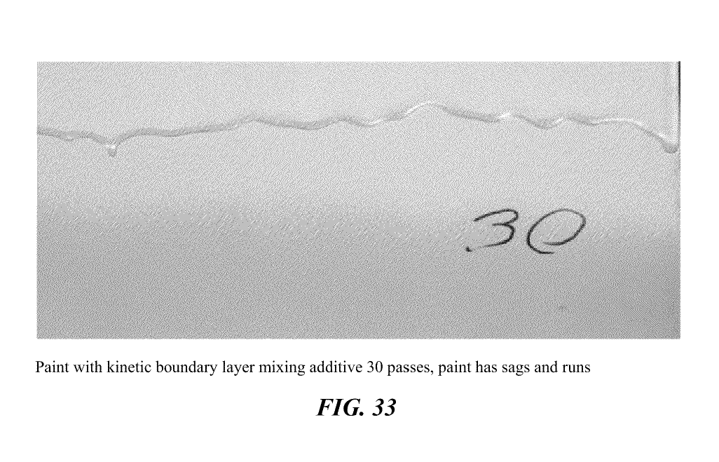

The paint sample with additives: the paint sagged and ran at 30 passes; see FIG. 33.

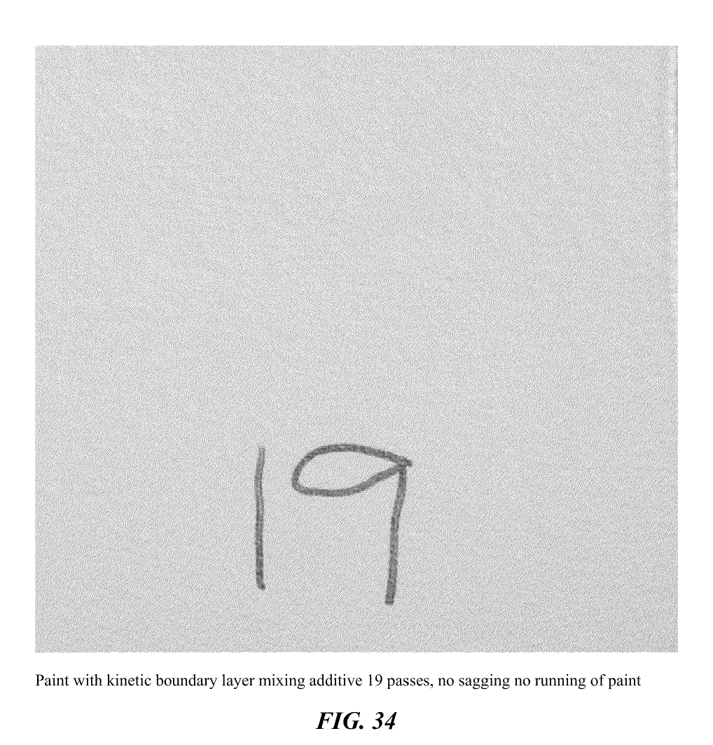

The paint sample with additive: the paint did not sag or run at 19 passes; see FIG. 34.

It is believed that the type (I) kinetic boundary layer mixing particle prevents paint from running because of the three dimensional thin protruding bladelike characteristics of the particle can pierce easily into the stagnant nonmoving boundary layer, which produced a, “mechanical locking system” when the paint stops moving. The particles produce a micron shelf system that prevents paint from sagging and running. This experiment shows that the addition of kinetic boundary layer mixing particles can significantly reduce mechanical spray errors, thereby making the paint more user-friendly and forgiving to the operator if excess paint is accidentally applied.

The kinetic boundary layer mixing particle creates a mechanical interaction rather than a chemical interaction with the paint to increase wettability and/or flow. Paint having kinetic mixing particles added thereto will have the same sag and run prevention characteristics whether the paint mixture is applied by roller, by brush, by airless sprayer (typical of water-based paints), or by LPHV system (typical for solvent-based paints). It is much easier to run a paint brush or a roller back over a surface to correct the error of paint sagging and running compared to the catastrophic mess you have when 6-8 feet of a sprayed wall starts to sag and then run as illustrated by FIGS. 32 and 33.

Automobile Paint

Primer and Paint manufactured by Spies Hecker Inc.

Primer: 5310 HS, Hardener: 3315 HS mix ratio 4:1

Paint: Chrysler, PB3 Calcdonia Blue, Series: 293 99384

Spray gun: SATA Jet 2000 Digital, Type: HVLP, Spray tip: 1.4 jet circular pattern

Additive was added at 1.0% by mass, Type (I) kinetic boundary layer mixing particle made from expanded perlite with an average particle size of 10μ. The type (I) kinetic boundary layer mixing particle was chosen because of its light weight and bladelike characteristics which mixes easily into fluids.

The mechanical mixing of additives into the automotive paint was accomplish with Hamilton Beach, Drink Master set at low RPMs with a mixing duration of 1 min.

The automotive paint was professionally applied by First Class Collision in Grove Oklahoma to standard sheet metal squares 4×6″.

Observation: both materials sprayed equally well and provided a smooth wet film. The surface color was darker with when kinetic mixing particles were added. Surface gloss was better with stock automotive paint. FIGS. 31A and 31B illustrate the color difference. Both paints receive a clearcoat as the final step in this process. Therefore, it is assumed that the rougher surface caused by the kinetic mixing particle will produce a better adhesive surface for the clearcoat.

Atomization Testing

Atomization testing was carried out into medias of water and then acrylic paint. 80% of architectural paints are acrylics and are water-based. Therefore, a kinetic boundary layer mixing particle that will be commercially accepted must not produce any negative effects on the commercial application of spraying.

Three particle sizes were used for the water analysis:

Boundary Breaker raw which is a mean average particle size of 30μ;

Boundary Breaker 20 which is a mean average particle size 20μ; and

Boundary Breaker 10 which as a mean average particle size 10μ.

Two particle sizes were used for acrylic paint testing:

Boundary Breaker 20 which is a mean average particle size 20μ; and

Boundary Breaker 10 which as a mean average particle size 10μ.

The testing was conducted at two different pressures, i.e., at 1000 PSI and 2000 PSI. The testing was conducted at two different nozzle distances, i.e., at 6 inches and 12 inches.

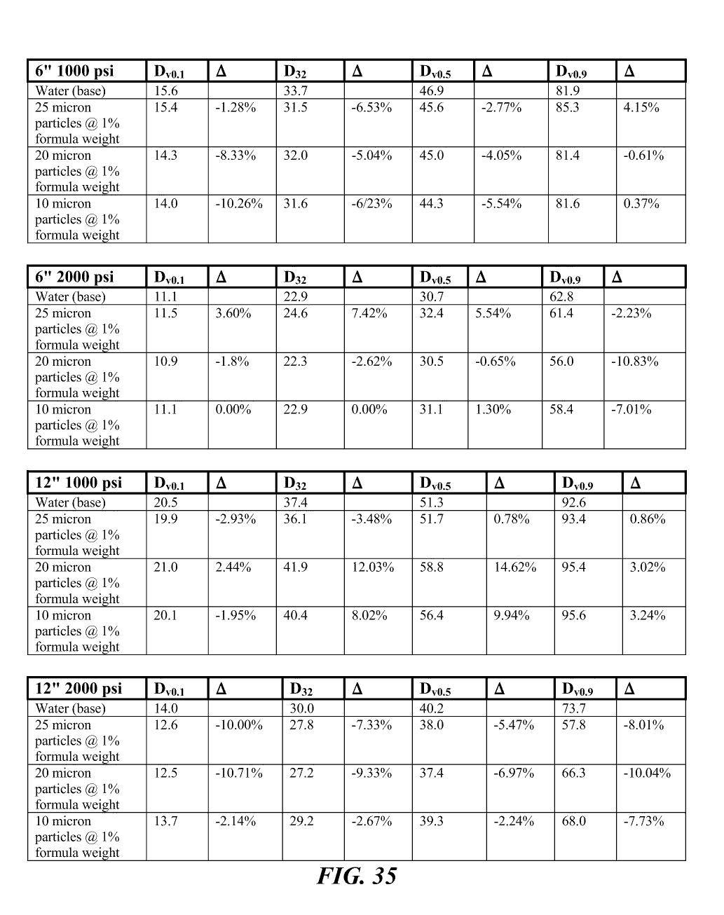

The conclusion of the atomization testing shows minimal deviation in drop size during atomization regardless of kinetic particle size and or whether the fluid was water or acrylic. Therefore, it is believed that commercial painters will be able to use their equipment as normal with no adverse effects on atomization through an airless spray system even though kinetic mixing particles are added to the paint. See full report in tabular form at FIG. 35.

Spray Systems

The addition of kinetic mixing particles to paint promotes better surface interaction of the wet film on a surface. When the atomized fluid impacts upon a surface, the atomized fluid will activate the kinetic mixing particles and move the boundary layer of the wet film as well as scrub the surface due to movement of the atomized particles on the surface, resulting in better coverage and a more uniform spray coating. This movement of the applied wet film during application reduces orange-peel effects of paint coatings. Additionally, the addition of kinetic mixing particles will increase adhesion of the paint to a surface, will increase surface wetting, will increase suspension of additives and will increase dispersion.

Other Areas of Application

Spray can applications for paint adhesives and foam will benefit from the addition of kinetic mixing particles because the addition of the particles increases the overall properties of surface coverage, film thickness, and helps keep spray tips from clogging.

Caulking can benefit from the addition of kinetic mixing particles by helping to promote improved flow and better surface interaction with the substrate when caulk is moved by a caulking gun or by other means.

In heavily filled adhesives such as carpet backing binder, where 60% to 80% by volume is calcium carbonate, the addition of kinetic mixing particles will increase the wettability, i.e., dry materials being coated by wet materials, thereby increasing the manufacturing throughput and improving overall product quality.

In foams, the addition of kinetic mixing particles promotes uniform cell structures with more consistent wall thickness for spray application or injection molding in single component materials, dual component materials and thermoplastic materials with blowing agents. Foams may be moved by impinging jet mixing systems.

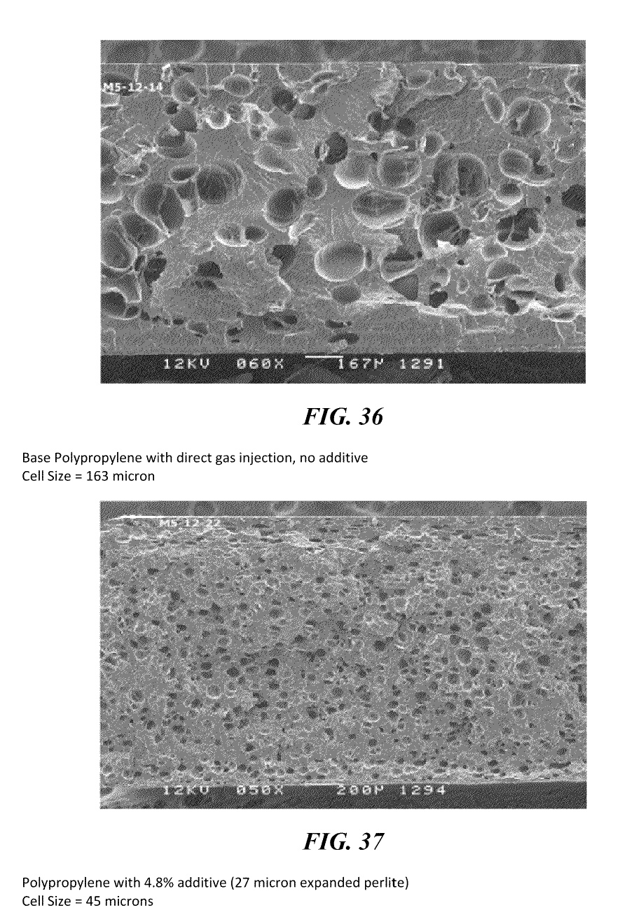

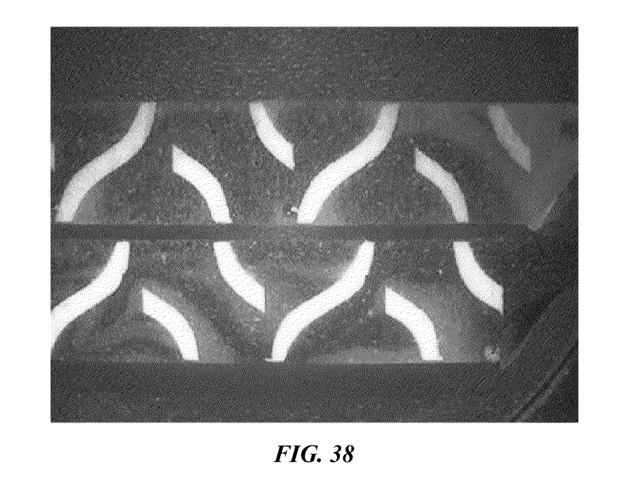

For example, sharp edged particles, when they are incorporated with a foaming agent, provide kinetic mixing that does not stop when the mixing step is done. The particles continue to remain active as the fluid moves during the expansion process. This promotes better dispersion of the blowing agents as well as increased mobility through better dispersion of reactive and nonreactive additives throughout the fluid during expansion of the foam thereby improving cellular consistency. The unique characteristics of three-dimensional, pointed, blade-like structures of the kinetic mixing material (Type I) produces excellent nucleation sites, thereby increasing cellular wall consistencies and strength. This phenomenon can be seen by comparing polypropylene foam with no additive (FIG. 36) and polypropylene foam with 4.8% additive of 27 micron expanded perlite (FIG. 37). FIG. 37 shows a substantial improvement in producing micro cell structures.

In two-component adhesives, the addition of kinetic mixing particles will help mix the liquid-to-liquid interface, promoting better cross linking throughout the polymer. The additive of kinetic mixing particles will additionally improve adhesive strength and impart better flow properties.

A static mixing test was conducted for dual component reactive materials:

Material: Loctite two component 60 min. epoxy, 2 pigments one yellow one green

Equipment: Standard 50 mL duel caulking gun with ¼ inch diameter 6 inch long disposable static mixer tip.

Experiment Set Up

100 ml of epoxy was reacted mixed and a small amount of yellow pigment was mixed in;

100 ml of epoxy was reacted mixed and a small amount of green pigment was mixed in;

The two 100 ml reacted epoxies with pigment within was then split in half 50 ml of yellow reacted epoxy was put in one half of a single dual component cartridge in a static mixer. In the other half of the static mixer, 50 ml of green reacted epoxy was located in the single dual component cartridge.

The 50 ml yellow reacted epoxy had 1% by mass kinetic mixing particles hand mixed therein. The yellow reacted epoxy was put in one half of the static mixer cartridge. 50 ml green reacted epoxy had 1% by mass kinetic mixing particles hand mixed therein. The 50 ml green reacted epoxy was then placed in the other side of the dual component cartridge. The mixing process was conducted for approximately 5 min. before the material was ejected out of the static mixing at the same low rate. The static mixing tubes were then allowed to be fully cured. The tubes were then cut in half using a waterjet cutter. As can be seen by reference to FIG. 38, the top sample, i.e., the sample with boundary breaker kinetic mixing particles is the more thoroughly mixed of the two samples. In other words, the top sample mixed the green and yellow reacted epoxy more thoroughly, resulting a greater amount of blue mixed epoxy.

### Example 1

The material designated as “Boundary Breaker” in the below example refers to Applicant's kinetic mixing particles, referred to above. Although a specific amount by weight is designated below, it should be understood that other amounts may also be effective. It is contemplated that a percentage by weight amount of 0.5% to 10% would be effective.

SEMI-TRANSPARENT STAIN Formulation ST337-2 Based on
Rhoplex ® AC-337N, and Acrysol* RM-825

| Materials | Pounds | Gallons |
|---|---|---|
| Water | 35.00 | 4.2 |
| Tamol 681^{a} | 2.50 | 0.3 |
| Foamaster AP^{b} | 2.00 | 0.3 |
| Super Seatone Trans-Oxide Red^{c} | 38.50 | 3.6 |
| Minex 7^{d} | 35.00 | 1.6 |
| Rhoplex AC-337N^{a} | 212.20 | 24.0 |
| Texanol^{e} | 7.82 | 1.0 |
| Propylene Glycol | 17.31 | 2.0 |
| Rozone 2000^{a} | 2.50 | 0.3 |
| MichemLUBE 270E^{f} | 20.00 | 2.4 |
| Acrysol RM-825^{a} | 15.00 | 1.7 |
| Aqueous Ammonia (28 be) | 0.50 | 0.1 |
| Water | 485.68 | 58.3 |
| Foamaster AP^{b} | 2.50 | 0.3 |
| Total | 876.51 | 100.00 |
| Boundary Breaker 2% by weight | 17.53 | Solid |
| Total | 894.04 | |
| Typical Values | | |
| Pigment Volume Concentration | 14.7% | |
| Volume Solids | 12.0% | |
| Initial Viscosity, KU | 65 ± 5 | |

^{a}Rohm and Haas Company
^{b}Henkel Corp.
^{c}Hilton Davis Corp.
^{d}Unimin Corp.
^{e}Eastman Chemical
^{f}Michelman Inc.

| | | | percent by |
|---|---|---|---|
| Manufacturer | product name | Additive type | weight |
| BASF | Acronal S 710 | acrylic binder | 30% |
| ROHM &HAAS | Rhoplex AC-337Na | acrylic binder | 24.4% |

In the above example, Acronal S 710 and Rhoplex AC-337Na are acrylic binders to which boundary Breaker particles will be added in amounts to equal 2% by weight when the acrylic binders are sold to paint formulation companies. Therefore, 30% by weight acrylic binder in a paint would result in 6.7% by weight of Boundary Breaker; 24.4% by weight acrylic binder in a paint would result in 8.2% by weight of Boundary Breaker. If 0.5% by weight Boundary Breaker were added to 30% by weight acrylic binder in paint, this would result in 1.7% Boundary Breaker by weight in the paint; If added to 24.4% by weight acrylic binder in paint, then 2% Boundary Breaker by weight in the paint would result.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A polymer mixture comprising:
a polymer having kinetic mixing particles dispersed therein;
wherein said kinetic mixing particles comprise particles wherein at least 20% of said particles have geometric shapes selected from a group consisting of points, sharp edges, accessible internal structures, voids or pockets that produce corners diamonds or triangles.

2. The polymer mixture according to claim 1 wherein:
said polymer is a paint binder.

3. The polymer mixture according to claim 1 wherein:
said kinetic mixing particles comprise at least 0.1% by mass of said polymer mixture.

4. The polymer mixture according to claim 1 wherein:
said kinetic mixing particles are comprised of Type I kinetic boundary layer mixing particles.

5. The polymer mixture according to claim 4 wherein:
said kinetic mixing particles are comprised of expanded perlite.

6. The polymer mixture according to claim 5 wherein:
said kinetic mixing particles have an average particle size of between approximately 500 nm to 100μ.

7. The polymer mixture according to claim 6 wherein:
said kinetic mixing particles have an average particle size of between 1μ and 30μ.

8. A method of increasing wettability of a polymer to a surface, improving polymer flow and increasing dispersion of additives comprising the steps of:
adding kinetic mixing particles to said polymer to form a polymer mixture;
moving said polymer over a surface;
tumbling said kinetic mixing particles at a boundary layer of said moving polymer.

9. The method according to claim 8 wherein:
said step of adding thickens said polymer.

10. The method according to claim 8 further comprising:
pigment particle additives in said polymer; wherein said pigment particles are mechanically processed into smaller particle sizes by said kinetic mixing particles for dispersing said pigment particles more homogeneously throughout the polymer mixture.

11. The method according to claim 8 wherein:
said tumbling of said kinetic mixing particles produce mechanical perforations through a polymer during kinetic rotation for allowing bubbles to escape the polymer.

12. The method according to claim 8 wherein:
at least 20% of said kinetic mixing particles define sharp edges that are capable of perforating bubbles in said polymer for defoaming said polymer.

13. The method according to claim 8 wherein:
said step of adding kinetic mixing particles to said polymer comprises the steps of:
adding said kinetic mixing particles in an amount that comprises at least 0.1% by mass of said polymer mixture.

14. The method according to claim 8 wherein:
said kinetic mixing particles are comprised of Type I kinetic boundary layer mixing particles.

15. The method according to claim 14 wherein:
said kinetic mixing particles are comprised of expanded perlite.

16. The method according to claim 15 wherein:
said kinetic mixing particles have an average particle size of between approximately 500 nm to 100μ.

17. The method according to claim 15 wherein:
said kinetic mixing particles have an average particle size of between approximately 1μ to 30μ.

18. The method according to claim 8 wherein said step of moving said polymer over a surface comprises:
atomizing said polymer with a spray apparatus.

19. The method according to claim 8 wherein said step of moving said polymer over a surface comprises:
applying said polymer to a surface with a paint brush.

20. The method according to claim 8 wherein said step of moving said polymer over a surface comprises:
applying said polymer to a surface with an airless sprayer.

21. The method according to claim 8 wherein said step of moving said polymer over a surface comprises:
applying said polymer to a surface with a LPHV system.

22. The method according to claim 8 wherein said step of moving said polymer over a surface comprises:
applying said polymer to a surface with a two-component impinging jet mixing system.
